(19) United States
(12) Patent Application Publication
(10) Pub. No.: US 2026/0058706 A1
(43) Pub. Date: Feb. 26, 2026

(54) ANTENNA LOCATION CONFIGURATIONS FOR PREDICTIVE BEAM MANAGEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Sony AKKARAKARAN, Poway, CA (US); Hamed PEZESHKI, San Diego, CA (US); Tao LUO, San Diego, CA (US)

(21) Appl. No.: 19/106,163

(22) PCT Filed: Oct. 21, 2022
(86) PCT No.: PCT/CN2022/126757

§ 371 Date: Feb. 24, 2025

(51) Int. Cl. H04B 7/06; H04W 72/232

(52) U.S. Cl. CPC H04B 7/0626; H04B 7/0617; H04W 72/232

(57) ABSTRACT

Methods, systems, and devices for wireless communications are described. In some aspects, a user equipment (UE) and a network entity may support a beamforming codebook configuration according to which the network entity may include, for each codepoint of the beamforming codebook, an indication of an antenna location and spatial information associated with a channel resource corresponding to that codepoint. In some aspects, the beamforming codebook may be specific to or associated with a serving cell of the network entity and the antenna locations indicated by the beamforming codebook may be associated with locations on an antenna panel of the network entity that is associated with the serving cell. The beamforming codebook may include antenna locations and spatial information for channel resources associated with beam measurement and channel resources associated with beam prediction.

### CROSS REFERENCE

The present Application is a 371 national stage filing of International PCT Application No. PCT/CN2022/126757 by LI et al. entitled “ANTENNA LOCATION CONFIGURATIONS FOR PREDICTIVE BEAM MANAGEMENT,” filed Oct. 21, 2022, which is assigned to the assignee hereof, and which is expressly incorporated by reference in its entirety herein.

### TECHNICAL FIELD

The following relates to wireless communications, including antenna location configurations for predictive beam management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support antenna location configurations for predictive beam management. For example, a user equipment (UE) may receive an indication or configuration of a beamforming codebook associated with a serving cell of a network entity and the beamforming codebook may indicate antenna locations and spatial information for channel resources associated with the beamforming codebook.

The channel resources associated with the beamforming codebook may include a first set of channel resources for channel measurement and a second set of channel resources for beam prediction and, in some implementations, the UE may identify, select, or otherwise determine associations or connections between the first set of channel resources and the second set of channel resources based on the antenna locations and the spatial information indicated via the beamforming codebook. For example, the UE may identify, select, or otherwise determine an association between a first channel resource of the first set of channel resources and a second channel resource of the second set of channel resources based on respective antenna locations of the first channel resource and the second channel resource. Accordingly, the UE may predict a signal strength for the second channel resource based on a channel measurement of the first channel resource and, in some implementations, may include the predicted signal strength for the second channel resource in a channel state information (CSI) report.

A method for wireless communication at a UE is described. The method may include receiving an indication of a beamforming codebook associated with a serving cell of a network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell, predicting one or more signal strengths associated with one or more channel resources of the second set of multiple channel resources based on a set of channel measurements associated with channel resources of the first set of multiple channel resources, the antenna locations, and the spatial information, and transmitting, to the network entity, a CSI report including the predicted one or more signal strengths associated with the one or more channel resources of the second set of multiple channel resources.

An apparatus for wireless communication at a UE is described. The apparatus may include at least one processor, memory coupled (e.g., operatively, communicatively, functionally, electronically, or electrically) with the at least one processor, and instructions stored in the memory. The instructions may be executable by the at least one processor to cause the UE to receive an indication of a beamforming codebook associated with a serving cell of a network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell, predict one or more signal strengths associated with one or more channel resources of the second set of multiple channel resources based on a set of channel measurements associated with channel resources of the first set of multiple channel resources, the antenna locations, and the spatial information, and transmit, to the network entity, a CSI report including the predicted one or more signal strengths associated with the one or more channel resources of the second set of multiple channel resources.

Another apparatus for wireless communication at a UE is described. The apparatus may include means for receiving an indication of a beamforming codebook associated with a serving cell of a network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell, means for predicting one or more signal strengths associated with one or more channel resources of the second set of multiple channel resources based on a set of channel measurements associated with channel resources of the first set of multiple channel resources, the antenna locations, and the spatial information, and means for transmitting, to the network entity, a CSI report including the predicted one or more signal strengths associated with the one or more channel resources of the second set of multiple channel resources.

A non-transitory computer-readable medium storing code for wireless communication at a UE is described. The code may include instructions executable by at least one processor to receive an indication of a beamforming codebook associated with a serving cell of a network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell, predict one or more signal strengths associated with one or more channel resources of the second set of multiple channel resources based on a set of channel measurements associated with channel resources of the first set of multiple channel resources, the antenna locations, and the spatial information, and transmit, to the network entity, a CSI report including the predicted one or more signal strengths associated with the one or more channel resources of the second set of multiple channel resources.

Some examples of the method, apparatuses, and non-transitory computer-readable medium described herein may further include operations, features, means, or instructions for receiving an indication of one or more codepoints associated with the beamforming codebook, where the one or more codepoints may be associated with the one or more channel resources of the second set of multiple channel resources, and where predicting the one or more signal strengths associated with the one or more channel resources may be based on receiving the indication of the one or more codepoints.

Some examples of the method, apparatuses, and non-transitory computer-readable medium described herein may further include operations, features, means, or instructions for receiving an indication of a reference point location associated with the antenna panel of the network entity associated with the serving cell, where the antenna locations indicated by the beamforming codebook may be indicated differentially relative to the reference point location.

Some examples of the method, apparatuses, and non-transitory computer-readable medium described herein may further include operations, features, means, or instructions for receiving an indication of a threshold distance associated with a correspondence between channel resources of the first set of multiple channel resources and channel resources of the second set of multiple channel resources, where predicting the one or more signal strengths associated with the one or more channel resources of the second set of multiple channel resources may be based on the threshold distance.

In some examples of the method, apparatuses, and non-transitory computer-readable medium described herein, predicting the one or more signal strengths associated with the one or more channel resources of the second set of multiple channel resources may include operations, features, means, or instructions for measuring a first signal strength of a first channel resource of the first set of multiple channel resources and predicting a second signal strength of a second channel resource of the second set of multiple channel resources based at least in part the first signal strength of the first channel resource, where the first channel resource and the second channel resource may be associated with each other for beam prediction in accordance with a first antenna location of the first channel resource and a second antenna location of the second channel resource being within the threshold distance of each other.

In some examples of the method, apparatuses, and non-transitory computer-readable medium described herein, multiple channel resources, including the second channel resource, of the second set of multiple channel resources may be associated with antenna locations that may be within the threshold distance of the first antenna location of the first channel resource and the second channel resource may be associated with the first channel resource for beam prediction in accordance with a distance between the first antenna location and the second antenna location being a relatively smallest distance.

In some examples of the method, apparatuses, and non-transitory computer-readable medium described herein, the indication of the threshold distance may be received from the network entity via radio resource control (RRC) signaling, a medium access control (MAC)-control element (CE), or a downlink control information (DCI) message, or any combination thereof.

Some examples of the method, apparatuses, and non-transitory computer-readable medium described herein may further include operations, features, means, or instructions for measuring a first signal strength associated with a first channel resource of the first set of multiple channel resources and a second signal strength associated with a second channel resource of the first set of multiple channel resources, where the first channel resource may be associated with a first set of channel resources of the second set of multiple channel resources and the second channel resource may be associated with a second set of channel resources of the second set of multiple channel resources and including one of a first set of predicted signal strengths associated with the first set of channel resources or a second set of predicted signal strengths associated with the second set of channel resources in the CSI report based on whether the first signal strength or the second signal strength may be a relatively greater signal strength.

In some examples of the method, apparatuses, and non-transitory computer-readable medium described herein, the first set of predicted signal strengths associated with the first set of channel resources of the second set of multiple channel resources may be included in the CSI report if the first signal strength may be the relatively greater signal strength and the second set of predicted signal strengths associated with the second set of channel resources of the second set of multiple channel resources may be included in the CSI report if the second signal strength may be the relatively greater signal strength.

Some examples of the method, apparatuses, and non-transitory computer-readable medium described herein may further include operations, features, means, or instructions for selecting associations between each channel resource of the first set of multiple channel resources and one or more channel resources of the second set of multiple channel resources, where the associations indicate for which one or more channel resources of the second set of multiple channel resources to make signal strength predictions based on a channel measurement of an associated channel resource of the first set of multiple channel resources.

In some examples of the method, apparatuses, and non-transitory computer-readable medium described herein, the associations may be based on the antenna locations of the first set of multiple channel resources and the second set of multiple channel resources first, and may be based on the spatial information of the first set of multiple channel resources and the second set of multiple channel resources second.

In some examples of the method, apparatuses, and non-transitory computer-readable medium described herein, the associations may be based on the spatial information of the first set of multiple channel resources and the second set of multiple channel resources first, and may be based on the antenna locations of the first set of multiple channel resources and the second set of multiple channel resources second.

In some examples of the method, apparatuses, and non-transitory computer-readable medium described herein, the beamforming codebook includes a set of multiple codepoints and each codepoint of the set of multiple codepoints includes a respective antenna location and respective spatial information for a respective channel resource.

In some examples of the method, apparatuses, and non-transitory computer-readable medium described herein, each codepoint of the set of multiple codepoints includes information indicative of an antenna location, a reference beam shape, and a beam pointing direction associated with a corresponding channel resource.

In some examples of the method, apparatuses, and non-transitory computer-readable medium described herein, each codepoint of the set of multiple codepoints includes information indicative of an antenna location, an antenna array structure, and a set of phase shifting values of antenna elements of the antenna array structure associated with a corresponding channel resource.

A method for wireless communication at a network entity is described. The method may include transmitting an indication of a beamforming codebook associated with a serving cell of the network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell and receiving a CSI report including one or more predicted signal strengths associated with one or more channel resources of the second set of multiple channel resources based on a set of channel measurements associated with channel resources of the first set of multiple channel resources, the antenna locations, and the spatial information.

An apparatus for wireless communication at a network entity is described. The apparatus may include at least one processor, memory coupled (e.g., operatively, communicatively, functionally, electronically, or electrically) with the at least one processor, and instructions stored in the memory. The instructions may be executable by the at least one processor to cause the network entity to transmit an indication of a beamforming codebook associated with a serving cell of the network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell and receive a CSI report including one or more predicted signal strengths associated with one or more channel resources of the second set of multiple channel resources based on a set of channel measurements associated with channel resources of the first set of multiple channel resources, the antenna locations, and the spatial information.

Another apparatus for wireless communication at a network entity is described. The apparatus may include means for transmitting an indication of a beamforming codebook associated with a serving cell of the network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell and means for receiving a CSI report including one or more predicted signal strengths associated with one or more channel resources of the second set of multiple channel resources based on a set of channel measurements associated with channel resources of the first set of multiple channel resources, the antenna locations, and the spatial information.

A non-transitory computer-readable medium storing code for wireless communication at a network entity is described. The code may include instructions executable by at least one processor to transmit an indication of a beamforming codebook associated with a serving cell of the network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell and receive a CSI report including one or more predicted signal strengths associated with one or more channel resources of the second set of multiple channel resources based on a set of channel measurements associated with channel resources of the first set of multiple channel resources, the antenna locations, and the spatial information.

Some examples of the method, apparatuses, and non-transitory computer-readable medium described herein may further include operations, features, means, or instructions for transmitting an indication of one or more codepoints associated with the beamforming codebook, where the one or more codepoints may be associated with the one or more channel resources of the second set of multiple channel resources, and where receiving the one or more predicted signal strengths associated with the one or more channel resources may be based on transmitting the indication of the one or more codepoints.

Some examples of the method, apparatuses, and non-transitory computer-readable medium described herein may further include operations, features, means, or instructions for transmitting an indication of a reference point location associated with the antenna panel of the network entity associated with the serving cell, where the antenna locations indicated by the beamforming codebook may be indicated differentially relative to the reference point location.

Some examples of the method, apparatuses, and non-transitory computer-readable medium described herein may further include operations, features, means, or instructions for transmitting an indication of a threshold distance associated with a correspondence between channel resources of the first set of multiple channel resources and channel resources of the second set of multiple channel resources, where receiving the one or more predicted signal strengths associated with the one or more channel resources of the second set of multiple channel resources may be based on the threshold distance.

In some examples of the method, apparatuses, and non-transitory computer-readable medium described herein, receiving the CSI report including the one or more predicted signal strengths may include operations, features, means, or instructions for receiving, based at least in part a measurement of a first signal strength of a first channel resource of the first set of multiple channel resources, a predicted signal strength of a second channel resource of the second set of multiple channel resources, where the first channel resource and the second channel resource may be associated with each other for beam prediction in accordance with a first antenna location of the first channel resource and a second antenna location of the second channel resource being within the threshold distance of each other.

In some examples of the method, apparatuses, and non-transitory computer-readable medium described herein, multiple channel resources, including the second channel resource, of the second set of multiple channel resources may be associated with antenna locations that may be within the threshold distance of the first antenna location of the first channel resource and the second channel resource may be associated with the first channel resource for beam prediction in accordance with a distance between the first antenna location and the second antenna location being a relatively smallest distance.

In some examples of the method, apparatuses, and non-transitory computer-readable medium described herein, the indication of the threshold distance may be transmitted via RRC signaling, a MAC-CE, or a DCI message, or any combination thereof.

In some examples of the method, apparatuses, and non-transitory computer-readable medium described herein, receiving the CSI report including the one or more predicted signal strengths may include operations, features, means, or instructions for receiving one of a first set of predicted signal strengths associated with a first set of channel resources or a second set of predicted signal strengths associated with a second set of channel resources, where the one of the first set of predicted signal strengths or the second set of predicted signal strengths may be based on whether a first signal strength associated with a first channel resource of the first set of multiple channel resources or a second signal strength associated with a second channel resource of the first set of multiple channel resources may be a relatively greater signal strength, where the first channel resource may be associated with the first set of channel resources of the second set of multiple channel resources and the second channel resource may be associated with the second set of channel resources of the second set of multiple channel resources.

In some examples of the method, apparatuses, and non-transitory computer-readable medium described herein, the first set of predicted signal strengths associated with the first set of channel resources of the second set of multiple channel resources may be included in the CSI report if the first signal strength may be the relatively greater signal strength and the second set of predicted signal strengths associated with the second set of channel resources of the second set of multiple channel resources may be included in the CSI report if the second signal strength may be the relatively greater signal strength.

Some examples of the method, apparatuses, and non-transitory computer-readable medium described herein may further include operations, features, means, or instructions for selecting associations between each channel resource of the first set of multiple channel resources and one or more channel resources of the second set of multiple channel resources, where the associations indicate for which one or more channel resources of the second set of multiple channel resources a UE may be to make signal strength predictions based on a channel measurement of an associated channel resource of the first set of multiple channel resources.

In some examples of the method, apparatuses, and non-transitory computer-readable medium described herein, the associations may be based on the antenna locations of the first set of multiple channel resources and the second set of multiple channel resources first, and may be based on the spatial information of the first set of multiple channel resources and the second set of multiple channel resources second.

In some examples of the method, apparatuses, and non-transitory computer-readable medium described herein, the associations may be based on the spatial information of the first set of multiple channel resources and the second set of multiple channel resources first, and may be based on the antenna locations of the first set of multiple channel resources and the second set of multiple channel resources second.

In some examples of the method, apparatuses, and non-transitory computer-readable medium described herein, the beamforming codebook includes a set of multiple codepoints and each codepoint of the set of multiple codepoints includes a respective antenna location and respective spatial information for a respective channel resource.

In some examples of the method, apparatuses, and non-transitory computer-readable medium described herein, each codepoint of the set of multiple codepoints includes information indicative of an antenna location, a reference beam shape, and a beam pointing direction associated with a corresponding channel resource.

In some examples of the method, apparatuses, and non-transitory computer-readable medium described herein, each codepoint of the set of multiple codepoints includes information indicative of an antenna location, an antenna array structure, and a set of phase shifting values of antenna elements of the antenna array structure associated with a corresponding channel resource.

### BRIEF DESCRIPTION OF THE DRAWINGS

FIG. 1 illustrates an example of a wireless communications system that supports antenna location configurations for predictive beam management in accordance with one or more aspects of the present disclosure.

FIG. 2 illustrates an example of a signaling diagram that supports antenna location configurations for predictive beam management in accordance with one or more aspects of the present disclosure.

FIG. 3 illustrates examples of beamforming codebook configurations that support antenna location configurations for predictive beam management in accordance with one or more aspects of the present disclosure.

FIG. 4 illustrates an example of a process flow that supports antenna location configurations for predictive beam management in accordance with one or more aspects of the present disclosure.

FIGS. 5 and 6 show block diagrams of devices that support antenna location configurations for predictive beam management in accordance with one or more aspects of the present disclosure.

FIG. 7 shows a block diagram of a communications manager that supports antenna location configurations for predictive beam management in accordance with one or more aspects of the present disclosure.

FIG. 8 shows a diagram of a system including a device that supports antenna location configurations for predictive beam management in accordance with one or more aspects of the present disclosure.

FIGS. 9 and 10 show block diagrams of devices that support antenna location configurations for predictive beam management in accordance with one or more aspects of the present disclosure.

FIG. 11 shows a block diagram of a communications manager that supports antenna location configurations for predictive beam management in accordance with one or more aspects of the present disclosure.

FIG. 12 shows a diagram of a system including a device that supports antenna location configurations for predictive beam management in accordance with one or more aspects of the present disclosure.

FIGS. 13 and 14 show flowcharts illustrating methods that support antenna location configurations for predictive beam management in accordance with one or more aspects of the present disclosure.

### DETAILED DESCRIPTION

In some systems, a user equipment (UE) may use a model, such as an artificial intelligence (AI) or machine learning (MIL) model, to predict information associated with a first set of beams based on a set of measurements of a second set of beams. For example, a UE may receive information associated with a first set of beams, referred to here as set A, and a second set of beams, referred to here as set B. In accordance with this received information, the UE may use signal strength measurements of the set B beams to predict signal strength measurements of the set A beams. In some aspects, the UE may receive an indication of a connection of respective beam shapes regarding set A and set B beams and may use the connection to assist in the signal strength predictions for the set A beams. If each beam of the set A beams and the set B beams is associated with a same antenna point location, connection between beams of set A and beams of set B based on respective beam shapes may be sufficient (e.g., facilitate sufficiently accurate predictions for set A beams).

As antenna array sizes increase, however, a network entity may use different sub-arrays (which may be distanced from each other) or different boresight leaving points for different beams. As such, relative antenna locations (e.g., boresight leaving locations) may influence which connections between set A beams and set B beams are suitable and, likewise, may influence signal strength predictions at the UE. For example, if a set A beam and a set B beam have a same beam shape but are associated with boresight leaving locations that are relatively distant from each other, use of the set B beam to predict a signal strength of the set A beam may result in an inaccurate signal strength prediction. Some systems, however, may lack a mechanism according to which a network entity may efficiently signal antenna locations of set A and set B beams to a UE such that the UE is able to use the antenna locations to identify or ascertain connections between set A and set B beams and make corresponding signal strength predictions of set A beams.

In some implementations, a UE and a network entity may support a beamforming codebook configuration according to which the network entity may include, for each codepoint of the beamforming codebook, an indication of an antenna location and spatial information associated with a channel resource corresponding to that codepoint. In some aspects, the beamforming codebook may be specific to or associated with a serving cell of the network entity. Likewise, the antenna locations indicated by the beamforming codebook may be associated with locations on an antenna panel of the network entity that is associated with the serving cell. Further, the beamforming codebook may include antenna locations and spatial information for channel resources associated with beam measurement (which may be associated with set B beams) and channel resources associated with beam prediction (which may be associated with set A beams).

As such, the UE may identify, select, ascertain, or otherwise determine connections or associations regarding set A and set B beams based on respective antenna locations together with respective spatial information (e.g., respective beam shapes) and the UE may predict signal strengths for one or more set A beams (e.g., one or more channel resources associated with beam prediction) based on the connections or associations. In some aspects, the UE may transmit a channel state information (CSI) report including the predicted signal strengths of the one or more set A beams. In some implementations, the UE may further use the connections or associations to generate the CSI report. For example, the UE may include predicted signal strengths of set A beams that are connected to or associated with a set B beam having a greatest measured signal strength and may exclude predicted signal strengths of set A beams that are not connected to or associated with the set B beam having the greatest measured signal strength.

Particular implementations of the subject matter described in this disclosure can be implemented to realize one or more of the following potential advantages. For example, as a result of supporting the beamforming codebook according to which a UE may predict and report signal strengths based on relative antenna locations between set A and set B beams, the UE may achieve lower signaling overhead and reduced measurement-related power consumption costs. In other words, enabling beam prediction for deployments in which a network entity uses a relatively large antenna array (e.g., deployments in which a network entity operates multiple sub-arrays) may reduce a quantity of reference signals that the network entity is expected to transmit and may reduce a quantity of resources via which the UE monitors and measures signal strengths. Further, the UE and the network entity may support one or more mutually understood or signaled rules associated with a quantity of predicted signal strengths that the UE may include in a CSI report in accordance with the described antenna location-based connections or associations between set A and set B beams. Moreover, supporting beam prediction procedures across diverse deployments, including deployments in which a network entity uses a relatively large antenna array, may facilitate wider of adoption of one or both of AI- or ML-based beam prediction and larger antenna array configurations, which may increase connectivity and reduce latency. As such, the UE and the network entity may employ the described techniques in various scenarios, including beam management procedures, and may experience higher data rates, greater capacity, and higher spectral efficiency.

Aspects of the disclosure are initially described in the context of wireless communications systems. Aspects of the disclosure are additionally illustrated by a signaling diagram, beamforming codebook configurations, and a process flow that relate to antenna location configurations for predictive beam management. Aspects of the disclosure are further illustrated by and described with reference to apparatus diagrams, system diagrams, and flowcharts that relate to antenna location configurations for predictive beam management.

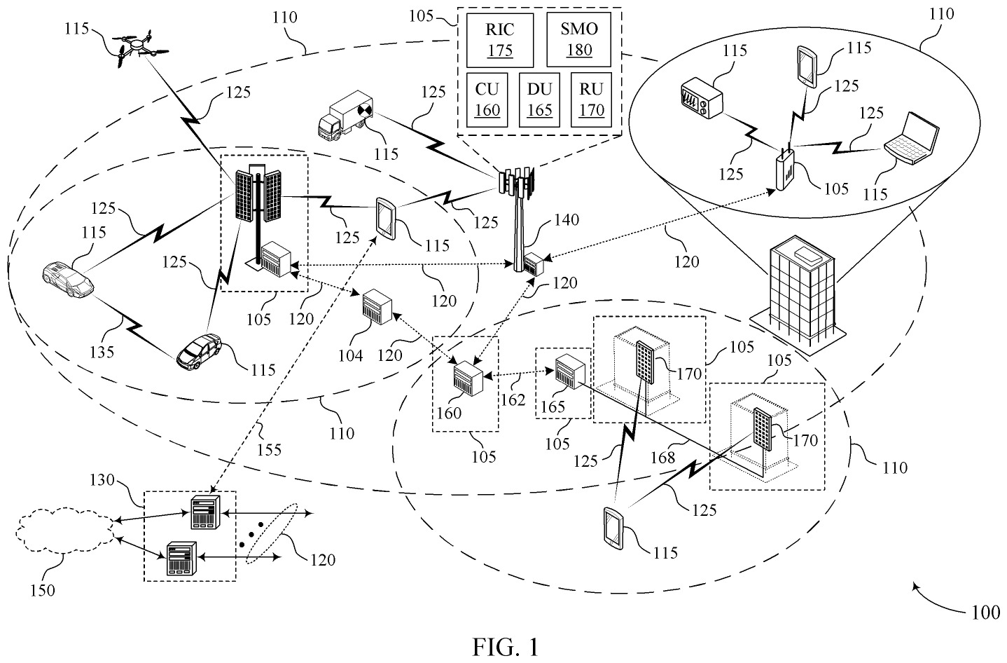

FIG. 1 illustrates an example of a wireless communications system 100 that supports antenna location configurations for predictive beam management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs). Components within a wireless communication system may be coupled (for example, operatively, communicatively, functionally, electronically, and/or electrically) to each other.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support antenna location configurations for predictive beam management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium, or a personal computer. In some examples, a UE 115 may include or be referred to as a wireless local loop (WLL) station, an Internet of Things (IoT) device, an Internet of Everything (IoE) device, or a machine type communications (MTC) device, which may be implemented in various objects such as appliances, or vehicles, or meters.

In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT). The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some aspects, the wireless communications system 100 may support one or more beam management techniques. For example, a UE 115 may be in an RRC idle state (e.g., RRC_IDLE) or an RRC inactive state (e.g., RRC_INACTIVE) and may transmit or receive one or more tracking reference signals (TRSs) prior to initial access. As part of initial access, one or more devices (e.g., one or both of a UE 115 and a network entity 105) may perform synchronization signal block (SSB) beam sweeping, which may be associated with wide beam sweeping. In some aspects, initial access may involve a contention based random access (CBRA) procedure associated with transmission or reception of random access channel (RACH) occasions (ROs) or preambles or transmission or reception of SSBs or a contention free random access (CFRA) procedure.

Upon establishment of a beam pair between two devices (e.g., between a UE 115 and a network entity 105), each device may perform beam management in an RRC connected state (e.g., RRC_CONNECTED). In some aspects, such beam management may include transmission or reception of one or more SSBs, one or more CSI reference signals (CSI-RSs), or one or more sounding reference signals (SRSs), Layer 1 (L1) reference signal received power (RSRP) reporting, and transmission configuration indicator (TCI) state configuration or indication. In some aspects, beam management (e.g., SSB or CSI-RS associated beam management) may be associated with a set of processes P1, P2, and P3 that are designed for beam management while a device is in a connected state. P1 may be associated with beam selection (e.g., a network entity 105 may sweep a beam and a UE 115 may select one of the beams and report the selected beam to the network entity 105), P2 may be associated with beam refinement for the transmitter (e.g., a network entity 105 may refine a beam via sweeping a narrower beam across a narrower range and a UE 115 may select one of the narrower beams and report the selected narrower beam to the network entity 105), and P3 may be associated with beam refinement for the receiver (e.g., a network entity 105 may fix a beam and a UE 115 may refine its receive beam). In some aspects, beam management (e.g., SRS associated beam management) may be associated with a set of different uplink beam management procedures U1, U2, and U3, where each beam management procedure may be associated with a beam sweep.

Additionally, or alternatively, beam management may include L1 signal-to-interference-plus-noise ratio (SINR) reporting and overhead and latency reduction. In some aspects, overhead and latency reduction may be associated with or otherwise involve one or more component carrier (CC) group beam updates and lower latency uplink beam updates. Further, in some aspects, beam management may involve beam measurement or reporting, or both with association to unified TCI states and L1 or Layer 2 (L2) centric mobility. For example, beam management procedures may include dynamic TCI state updates, uplink multi-panel selection, maximum permissible exposure (MPE) mitigation, or other techniques that facilitate further beam management latency reduction. Further, some beam management procedures may include procedures associated high speed train (HST) deployments, single frequency network (SFN) deployments, or multi-TRP deployments, or any combination thereof.

In some aspects, a device may measure, identify, or otherwise experience a beam failure detection (BFD) based on measurements associated with beam management and may perform one or more beam failure recovery procedures. BFD and a beam failure recovery (BFR) may be performed for a primary cell (PCell), a primary secondary cell (PSCell), or a secondary cell (SCell). Further, BFD and BFR may involve transmission or reception of one or more BFD reference signals (BFD-RSs), a physical downlink control channel (PDCCH) block error rate (BLER) measurement, a link recovery request via a scheduling request (SR), or a MAC-CE-based BFR for SCell, or any combination thereof. In some cases, such as in cases in which a device is unable to recover a failed beam pair link, the device may declare a radio link failure (RLF) and attempt to re-establish a connection via one or more initial establishment procedures.

Various devices of the wireless communications system 100 may support one or more AI or ML models associated with air-interface predictions (e.g., predictions associated with wireless communication). In some deployments, for example, a device may leverage or use an AI or ML model for CSI feedback enhancement (e.g., for overhead reduction, greater accuracy, and more accurate prediction), beam management (e.g., beam prediction in time or spatial domain for overhead and latency reduction as well as for greater beam selection accuracy), or positioning accuracy enhancements for different scenarios (e.g., scenarios associated with heavy non-line-of-sight (NLOS) conditions).

In some cases, the device may leverage or use an AI or ML model for a specific use case such that the AI or ML model approach is diverse enough to support various constraints on collaboration levels between a UE 115 and a network entity 105. Further, various devices may support one or both of an AI or ML model or description to identify common and specific characteristics for framework investigations or decisions. For example, devices may support a model and description to characterize lifecycle management of an AI or ML, model, such as aspects relating to model training, model deployment, model inference, model monitoring, or model updating.

In some deployments, a UE 115 or a network entity 105 may use AI or ML based predictive beam management (e.g., for Uu beam management). For example, other beam management techniques may involve an identification of beam qualities or failures via measurements, which may be associated with greater power or overhead to achieve suitable performance. Further, measurement-based beam management may be associated with a limited accuracy due to constraints on power or overhead and latency and throughput may be adversely impacted by beam resumption efforts. Predictive beam management, on the other hand, may be associated with power or overhead reduction, greater accuracy, lower latency, or higher throughput. For example, a predictive beam management procedure may enable a device to predict non-measured beam qualities (which may be associated with lower power consumption, lower overhead, or greater beam selection accuracy) and to predict future beam blockages or failures (which may be associated with lower latency and greater throughput). Such predictive beam management may involve predictions in a spatial domain, a time domain, a frequency domain, or any combination thereof.

Some devices may specifically employ AI or ML to compensate or address that beam prediction may be a highly non-linear problem in some deployments. For example, predicting a future transmit beam quality may depend on a speed or trajectory of a UE 115, one or more receive beams that are to be used, or interference, which may be difficult to model via some statistical signaling processing methods (e.g., non-AI or ML based statistical processing methods). In some deployments, there may be a tradeoff between performance and UE power consumption based on whether beam prediction is performed at a UE 115 or a network entity 105. For example, to predict future downlink transmit beam qualities, a UE 115 may have more observations (e.g., via measurements) than a network entity 105 (e.g., via UE feedback messages), thus beam prediction at a UE 115 may outperform beam prediction at a network entity 105 (at the cost of consuming more UE power for the prediction or inference processing tasks). Further, model training may be performed at either a UE 115 or a network entity 105 and a decision between training location may be associated with efforts on data collection as compared to efforts on UE computation. For example, if training is performed by a network entity 105, data may be collected via an air interface or via application layer approaches. If training is performed by a UE 115, the UE 115 may perform additional UE computation or buffering tasks for the model training and associated data storage.

AI or ML-based spatial domain or time domain beam prediction or selection (e.g., for downlink) may relate to one or more of various procedures. For example, AI or ML-based spatial domain or time domain beam prediction or selection may be used for initial access, secondary cell group (SCG) setup, serving beam refinement, link quality and interference adaptation (e.g., one or more parameters, such as a channel quality indicator (CQI) or a precoding matrix indicator (PMI)), beam failure or blockage prediction, or RLF prediction. In some aspects, specific one or more selection or prediction schemes may be used for each of such various procedures. For example, codebook-based spatial domain selection may be used for initial access, SCG setup, serving beam refinement, or link quality and interference adaptation. Non-codebook-based spatial domain prediction may be used for serving beam refinement and link quality and interference adaptation. Additionally, or alternatively, joint spatial domain and time domain beam prediction may be used for serving beam refinement, link quality and interference adaptation, beam failure or blockage prediction, or RLF failure prediction.

Codebook-based spatial domain selection may be associated with an input of a first set of beams (e.g., measurements of a first set of beams) and a predicted output (e.g., an output of an AI or ML model) of a second set of beams (e.g., a predicted set of beams). For interference at a network entity 105, the input may be associated with or include UE feedbacks and side information (e.g., history or location information. For inference at a UE 115, the input may be associated with or include UE measurements and side information (e.g., location information). A UE 115 may report or measure such measurement information using spatial domain or time domain compressive beam measurements. Codebook-based spatial domain selection may be associated with fewer beam measurements, which may lead to power reduction at a measuring device (e.g., a UE 115).

Non-codebook-based spatial domain prediction may be associated with an input of a set of channels or beams (e.g., measurements associated with a set of channels or beams) and an output of a point direction, an angle of departure (AoD), or an angle of arrival (AoA). For inference at a network entity 105, the input may be associated with or include UE feedbacks and side information (e.g., history or location information). For inference at a UE 115, the input may be associated with or include UE measurements and side information (e.g., location information). Such reporting or measuring of such measurement information at a UE 115 may be facilitated via raw channel extraction. Non-codebook-based spatial domain prediction may be associated with greater beam management accuracy without excessive beam sweepings.

From spatial domain to spatial domain plus time domain, joint spatial domain and time domain beam prediction may be associated with a time series input and outputs associated with both codebook-based spatial domain and time domain beam prediction and non-codebook-based spatial domain and time domain point direction, AoD, or AoA prediction. The time series input may include a UE report or measurement at a first time or measurement occasion (e.g., a measurement occasion #0) through a UE report or measurement at an N^{th} time or measurement occasion (e.g., a measurement occasion #N). In accordance with the joint spatial domain and time domain beam prediction, the time series input may be input to a first AI or ML model to obtain a first output of codebook-based spatial domain and time domain beam prediction and may be input to second AI or ML model to obtain a second output of non-codebook-based spatial domain and time domain point direction, AoD, or AoA prediction.

Prediction performance or costs may depend on whether prediction is performed by a UE 115 or a network entity 105. If prediction is performed at a network entity 105, the network entity 105 may use relatively more powerful computational capabilities (e.g., as compared to a UE 115), access to historical and location-wise L1 report distributions, access to feedbacks or locations of other UEs 115, awareness of transmit beam shapes and pointing directions to assist in beam prediction. In some deployments, prediction performance at the network entity 105 may be balanced with other factors, such as that only a strongest one or more beams may be reported by a UE 115, a difficulty to know receive beams used to derive the L1 or CSI feedbacks, (all) UE feedbacks being quantized (and could potentially be missed), and that it may be difficult to know an orientation or rotation status of a UE 115. If beam prediction is performed at a UE 115, the UE 115 may use access to instantaneous and filtered measurements of a set of (e.g., all) beams, access to the receive beams used to derive the measurements, (all) measurements being raw or non-quantized, and an awareness (at least in part) of or an ability to predict its own orientation and rotation to assist in beam prediction. In some deployments, prediction performance at the UE 115 may be balanced with other factors, such as that the UE 115 may have relatively limited computational capabilities, relatively limited knowledge on historical distribution of L1 reports in the cell, a difficulty to access L1 or CSI feedbacks of other UEs 115, or a relatively limited indication or perception on transmit beam shapes or pointing directions. In some aspects, a UE 115 may transmit assistance information to assist in a beam prediction configuration.

In some deployments, devices of the wireless communications system 100 may support, for AI or ML-based beam management, one or more beam management cases for characterization and baseline performance evaluations. A first beam management case, or BM-Case1, may be associated with spatial domain downlink beam prediction for a set A of beams based on measurement results of a set B of beams. A second beam management case, or BM-Case2, may be associated with temporal downlink beam prediction for a set A of beams based on historic (e.g., previous) measurement results of a set B of beams. For use cases of BM-Case1 or BM-Case2, or both, a UE 115 or a network entity 105 may support downlink transmit beam prediction, downlink receive beam prediction, or beam pair prediction (where a beam pair may include a downlink transmit beam and a corresponding downlink receive beam).

Beams of the set A and the set B may be in a same frequency range or in different frequency ranges. In some aspects, set B may be a subset of set A, where the number of beams in set A and in set B may vary. In some other aspects, set A and set B may be the same. In some other aspects, set A and set B may be different. For example, set A may include a set of relatively narrower beams and set B may include a set of relatively wider beams. In such aspects, where the number of beams in set A and in set B may vary and there may be a defined quasi-colocation (QCL) relation between beams in set A and beams in set B. Further, various types or implementations of codebook constructions of set A and set B may be used without exceeding the scope of the present disclosure. In the context of such a set A of beams and a set B of beams, set A may be for downlink beam prediction and set B may be for downlink beam measurement.

A UE 115 may receive control signaling from a network entity 105 that indicates, configures, activates, or triggers a CSI report from the UE 115. For example, a UE 115 may be configured to transmit one or more synchronization signal (SS)/physical broadcast channel (PBCH) resource indicator (SSBRI) or a CSI-RS resource indicator (CRI) and L1-RSRP or L1-SINR reports via one or more CSI reports. In some deployments, a UE 115 may receive (e.g., be configured with) a ReportQuantity=ssb-Index-RSRP, ssb-Index-SINR, cri-RSRP, or cri-SINR for joint S SBRI/CRI and L1-RSRP/L1-SINR beam reporting. The UE 115 may report (e.g., transmit) a nrofReportedRS parameter (which may be RRC configured, and may be up to 2 or 4 depending on UE capability), which may be different for SSBRI or CRI for each CSI-ReportConfig.

For L1-RSRP reporting, for a strongest SSBRI/CRI, 7 bits may be used to report RSRP in a range of [−140, −44] dBm with a 1 dBm step size. For remaining SSBRI(s)/CRI(s), 4 bits may be used to report a differential RSRP in a range of [0, −30] dB with a 2 dB step size and a reference to the L1-RSRP of the strongest SSBRI/CRI (e.g., the greatest RSRP reported, in absolute or full terms, via the 7 bits). For the L1-RSRP of the strongest SSBRI/CRI, there may be one or more invalid codepoints considering that 2′=128 but 140-44+1=97. In some systems, a mapping between the reported 7-bit and 4-bit codepoints and the actually measured RSRP values may be defined by a specification, such as a network specification.

Similarly, for L1-SINR reporting, for a strongest SSBRI/CRI, 7 bits may be used to report SINR in a range of [−23, 40] dB with a 0.5 dB step size. For remaining SSBRI(s)/CRI(s), 4 bits may be used to report a differential SINR in a range of [0, −15] dB with a 1 dB step size and a reference to the L1-SINR of the strongest SSBRI/CRI (e.g., the greatest SINR reported, in absolute or full terms, via the 7 bits). For the strongest and the remaining SSBRI(s)/CRI(s), there may be no invalid codepoints, but SINR_0 may stand for an SINR of less than or equal to −23 dB for the strongest SSBRI/CRI, while DIFFSINR_15 may stand for a delta SINR of less than or equal to −15 dB. In some systems, a mapping between the reported 7-bit and 4-bit codepoints and the actually measured SINR values may be defined by a specification, such as a network specification.

In some deployments, various devices in the wireless communications system 100 may support CSI reporting in mTRP deployments. For example, when associated with an aperiodic resource setting, such devices may extend an RRC parameter CSI-AssociatedReportConfigInfo to be configured with two CMR sets, where each may be configured or associated with respective QCL information. When associated with a periodic or semi-persistent resource setting, the resource setting may include two CMR sets. In some deployments, devices may support less than or equal to 2 beams per group M for some beam reporting options.

In some aspects, a UE 115 and a network entity 105 may support a serving cell-specific beamforming codebook (e.g., a ServingCell-specific RRC configured beamforming codebook), which may be selected by the UE 115 via one or more codepoint indices for a first set of beams, referred to as set A, and a second set of beams, referred to as set B, involved in CSI reporting. In some aspects, such a codebook may include indications of absolute beam shapes or options of components associated with beam shapes (e.g., point directions and width information, or array structures and phase shifting values). In such aspects, a connection or relationship of respective beam shapes regarding set A and set B beams may be indicated (e.g., from a network entity 105 to a UE 115) in various levels, including resource level, resource set level, CSI resource setting level, CSI report setting level, or MAC-CE or downlink control information (DCI) dynamic indication level).

In some systems, codebook construction and connections or relationships between set A and set B beams may be configured assuming or expecting that antenna reference point locations are identical for different set A and set B beams, or that beams are transmitted from a network entity 105 by using all antenna elements at a panel of the network entity 105. However, as antenna arrays of network entities 105 get bigger (e.g., such as in deployments of large intelligent surfaces (LISs) or reconfigurable/reflective intelligent surfaces (RISs) at a network entity 105), a network entity 105 may transmit using different transmit beams from different sub-arrays that may be physically distanced from each other. In other words, different transmit beams of a network entity 105 may be associated with various boresight leaving points, where some of such boresight leaving points may be relatively far from each other. Such various boresight leaving points may be a factor in beam prediction (e.g., information relating to antenna locations may impact receive beam selection and beam prediction performance at a UE 115). A UE 115, however, may be unaware of such various boresight leaving points of different transmit beams used by a network entity 105, which may result in inaccurate beam predictions at the UE 115.

Further, although a UE 115 and a network entity 105 may support indicating various antenna locations (e.g., physical locations of the antennas within a grid of an antenna panel, boresight leaving points, or other indications of one or more antenna locations within one or more antenna panels) for different downlink positioning reference signal (DL-PRS) resources, such indications may be associated with relatively large indicating or configuration overhead (e.g., as such indications may be specifically indicated for each PRS resource). In some aspects, relay more compact or efficient configurations may be more suitable for predictive beam management, especially considering cases in which codebooks may be dynamically varied.

Accordingly, in some implementations, a UE 115 and a network entity 105 may support serving cell (e.g., ServCell)-specifically configured antenna locations. In some aspects, the serving cell-specifically configured antenna locations may be configured or indicated along with serving cell specific configured beamforming codebooks. In some implementations, connections of respective antenna locations together with respective beam shapes regarding set A and set B beams may be indicated in various levels, including resource level, resource set level, CSI resource setting level, CSI report setting level, or MAC-CE or DCI dynamic indication level.

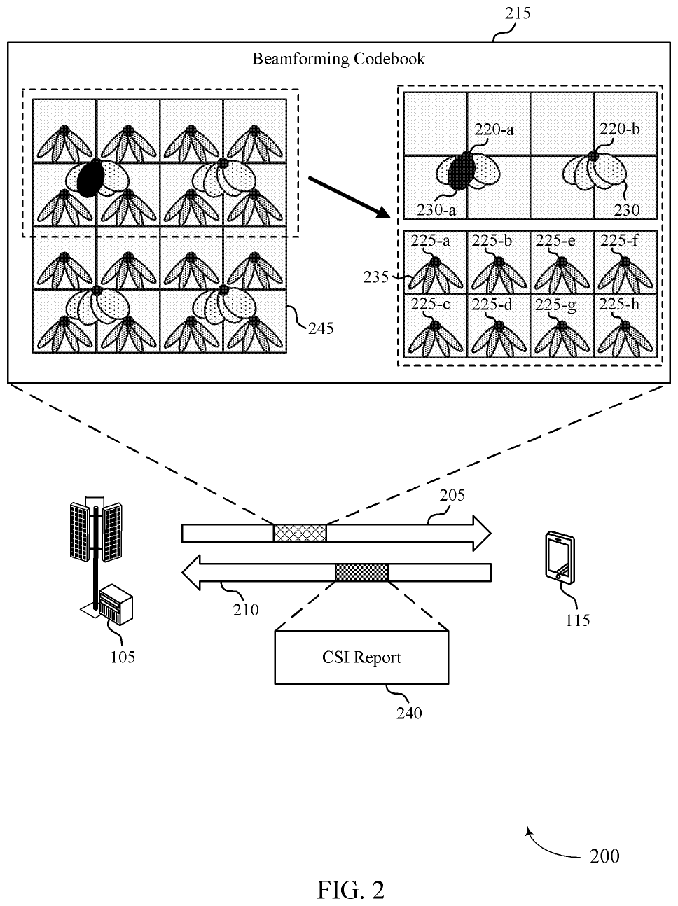

FIG. 2 illustrates an example of a signaling diagram 200 that supports antenna location configurations for predictive beam management in accordance with one or more aspects of the present disclosure. The signaling diagram 200 may implement or be implemented to realize aspects of the wireless communications system 100. For example, the signaling diagram 200 illustrates communication between a UE 115 and a network entity 105, which may be examples of corresponding devices described herein, including with reference to FIG. 1. The network entity 105 may transmit signaling to the UE 115 via a downlink 205 and the UE 115 may transmit signaling to the network entity 105 via an uplink 210. In some implementations, the UE 115 and the network entity 105 may support a beamforming codebook 215 according to which the network entity 105 may indicate antenna locations 220 and 225 for various channel resources associated with the beamforming codebook 215.

The beamforming codebook 215 may be a codebook of beams formable by a serving cell associated with the network entity 105 and may be configured (e.g., RRC configured) via signaling associated with a configuration of the serving cell. In some aspects, the various channel resources associated with the beamforming codebook 215 may include a first set of channel resources for channel measurement and a second set of channel resources for beam prediction. The first set of channel resources for channel measurement may be associated with a set of beams 230, which may be associated with or referred to as a set B of beams, and the second set of channel resources for beam prediction may be associated with a set of beams 235, which may be associated with or referred to as a set A of beams. In some aspects, the set of beams 230 may be relatively wider beams and the set of beams 235 may be relatively narrower beams.

As described herein, a set A of beams may be predicted and a set B of beams may actually be measured. For example, the network entity 105 may transmit one or more reference signals using each beam of a set B of beams via channel resources of the first set of channel resources for channel measurement. Further, the UE 115 may predict measurement information (e.g., a signal strength, such as an L1-RSRP or L1-SINR measurement) for each of at least a subset of set A beams associated with the network entity 105.

The first set of channel resources and the second set of channel resources may be associated with (e.g., connected to) each other, which may refer to how the UE 115 uses measurements of one or more channel resources of the first set of channel resources to predict measurements of one or more channel resources of the second set of channel resources. Further, although described herein as a second set of channel resources for beam prediction, channel resources of the second set of channel resources may additionally, or alternatively, be part of set of channel resources for channel measurement, where such a set of channel resources may be configured, indicated, or defined as being for or associated with channel measurement or beam prediction functions. The UE 115 may receive configuration information associated with the first set of channel resources and the second set of channel resources, and potentially also information indicative of the associations (e.g., connections) between the first set of channel resources and the second set of channel resources, via the beamforming codebook 215, a CSI report setting, separate signaling, or any combination thereof.

In some implementations, the UE 115 and the network entity 105 may leverage the beamforming codebook 215 (e.g., a ServCell specific beamforming codebook) for predictive beam management. For example, the UE 115 may receive an indication of a number (e.g., a quantity) of transmit antenna locations, which may be identified by the beamforming codebook 215 within the specific serving cell, and which may be applied to channel resources associated with the beamforming codebook 215. As described herein, the channel resources of the first set of channel resources may be referred to as channel measurement resources (CMRs), including SSBs or CSI-RSs, and channel resources of the second set of channel resources may be CMRs or virtual or nominal resources that are not actually transmitted (e.g., not expected to be transmitted by the network entity 105 or measured by the UE 115).

As illustrated in the example of FIG. 2, the beamforming codebook 215 may indicate antenna locations 220 (e.g., including an antenna location 220-a and an antenna location 220-b) for channel resources of the first set of channel resources for channel measurement (which may be associated with the set of beams 230) and may indicate antenna locations 225 (e.g., including an antenna location 225-a, an antenna location 225-b, an antenna location 225-c, an antenna location 225-d, an antenna location 225-e, an antenna location 225-f, an antenna location 225-g, and an antenna location 225-h) for channel resources of the second set of channel resources for beam prediction (which may be associated with the set of beams 235). In some aspects, the set of beams 230 may be relatively wide beams and may be associated with antenna locations 220 residing at four respective points within the antenna panel 245. The set of beams 235 may be relatively narrow beams and may be associated with antenna locations 225 residing at 16 respective points surrounding the four points associated with the set B beams.

In some examples, the beamforming codebook 215 may indicate the antenna locations 220 and the antenna locations 225 in accordance with a differential antenna location configuration. For example, the configuration or indication of the antenna locations in respective beamforming codepoints may be based on a configuring of a serving cell specifically defined antenna reference point location. In such examples, indications of the antenna locations for a given beamforming codepoint may be made by indicating a differential location referring to the serving cell specifically defined antenna reference point location. In other words, the network entity 105 may indicate a reference point location that is specific to both the antenna panel 245 of the network entity 105 and the corresponding serving cell of the network entity 105 and may indicate, via the beamforming codebook 215, the antenna locations 220 and the antenna locations 225 differentially relative to the reference point location.

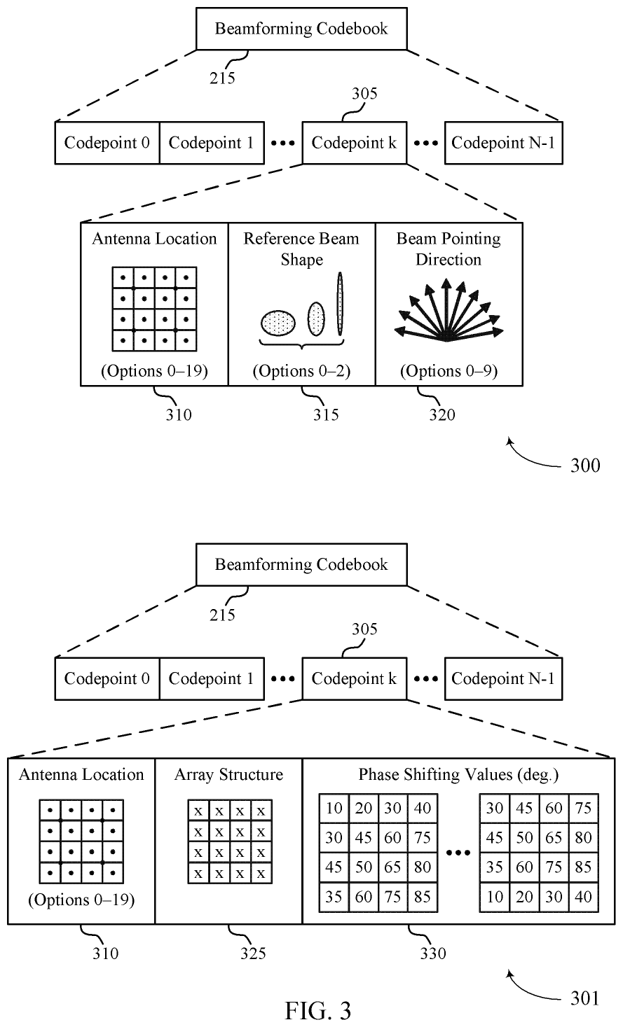

Further, in addition to the transmit antenna locations, the beamforming codebook 215 may also include spatial information, which may include beam pointing directions or angular-specific beamforming gain information, of the respective beam codepoints included in the beamforming codebook 215. As such, the UE 115 may identify, select, or otherwise determine antenna locations of both the first set of channel resources and the second set of channel resources (which may include CMRs or virtual or nominal resources) based on further connections that may be configured or indicated associating the resources with at least one codepoint within the beamforming codebook 215. Additional details relating to the spatial information included by the beamforming codebook 215 are illustrated by and described with reference to FIG. 3.

In some implementations, the UE 115 and the network entity 105 may support connections between the first set of channel resources (e.g., which may be associated with set B beams) and the second set of channel resources (e.g., which may be associated with set A beams) in accordance with or based on the antenna locations indicated by the beamforming codebook 215. In some aspects, for example, the UE 115 may further identify connections (in terms of antenna locations) between a first subset of resources within the first set of channel resources and a second subset of resources within the second set of channel resources based on a threshold distance. For example, the network entity 105 may configure (e.g., via RRC signaling) or indicate (e.g., via a MAC-CE or DCI) that, if an antenna location 225 of a second resource within the second set of channel resources is within the threshold distance (e.g., X centimeters) from a first resource within the first set of channel resources, the first resource and the second resource may be connected or associated (e.g., for the purpose of beam prediction). Additionally, or alternatively, a network specification may indicate that a set of resources from the first set of channel resources and the second set of channel resources are associated or connected if the antenna locations of the resources are within the threshold distance of each other.

In some implementations, a value or a set of possible values for the threshold distance (e.g., X) may be defined or indicated by a network specification. Additionally, or alternatively, the UE 115 may receive an indication of the threshold distance via signaling from the network entity 105. In some aspects, the threshold distance may be RRC configured. In such aspects, a value of X may be configured per serving cell together with the beamforming codebook 215, configured by a CSI reporting setting, or configured by a CSI resource setting associated with one or both of the first set of channel resources and the second set of channel resources. In some aspects, the threshold distance may be MAC-CE indicated. In such aspects, a value of X may be indicated by a MAC-CE activating a CSI report 240 (e.g., a semi-persistent CSI report) associated with the first set of channel resources and the second set of channel resources or indicated by a MAC-CE activating a CSI resource set being the first set of channel resources and the second set of channel resources. In some aspects, the threshold distance may be DCI indicated. In such aspects, a value of X may be configured by an aperiodic CSI triggering state configuration and indicated by DCI when the CSI report associated with the aperiodic CSI triggering state is triggered by the DCI.

If a second resource from the second set of channel resources is associated with or connected to multiple first resources from the first set of channel resources, the UE 115 may identify, select, or otherwise determine a single first resource from the first set of channel resources that is connected with the second resource. In some implementations, the UE 115 may select the single first resource from the first set of channel resources in accordance with the single first resource being associated with an antenna location that is closest to an antenna location of the second resource.

Further, in some implementations, the UE 115 may select, identify, ascertain, or otherwise determine associations or connections between channel resources of the first set of channel resources and channel resources of the second set of channel resources in accordance with a connection priority order of different codebook components. In other words, the UE 115 may support or consider priority orders among multiple codebook components (e.g., parameters or other information conveyed by the beamforming codebook 215) when identifying, selecting, ascertaining, or otherwise determining the connections or associations between the resources in the first set of channel resources and the resources in the second set of channel resources. In some examples, the multiple codebook components may include antenna location differences between the respective resources, beam pointing direction differences (in terms of, for example, X₁/X₂ dB beam widths), beam shape differences, or phase shifting values differences between the respective resources.

In some implementations, the connections between the resources may be initially prioritized based on a first component and secondly prioritized based on a second component. For example, the UE 115 may first identify connections according to antenna locations and then identify (or narrow) connections according to beam pointing directions. As such, the UE 115 may identify preliminary connections between the first set of channel resources and the second set of channel resources based on respective antenna locations and may identify refined connections between the first set of channel resources and the second set of channel resources based on respective beam pointing directions of the channel resources. For further example, the UE 115 may first identify connections according to beam point direction and then identify (or narrow) connections according to antenna locations. In some aspects, a preliminary connection may include connections between multiple first resources of the first set of channel resources and a second channel resource of the second set of channel resources and a refined connection may include a connection between a smaller set of first resources (e.g., a single first resource) of the first set of channel resources and the second channel resource.

The UE 115 may receive, from the network entity 105, an indication of one or more codepoints in the beamforming codebook 215 for channel resources. In some aspects, the UE 115 may receive the indication of the one or more codepoints via signaling with respect to the CSI report 240. The UE 115 may accordingly identify connections between channel resources of the first set of channel resources and channel resources of the second set of channel resources based on the indicated beamforming codepoints and may associate the channel resources indicated by the beamforming codepoints, along with any connected channel resources, with a CSI report for the serving cell of the network entity 105.

In some implementations, the UE 115 and the network entity 105 may support QCL or report quantity behaviors based on antenna location connections. For example, the UE 115 may identify the QCL or report quantities, or both, based on the antenna location-based connections. In some examples, for the report quantities associated with the second set of channel resources for beam prediction, the UE 115 may address (e.g., include in the CSI report 240) channel resources of the second set of channel resources that are connected to a first resource of the first set of channel resources that is associated with a strongest channel measurement (e.g., a strongest L1-RSRP) among a remainder of the first set of channel resources.

For example, if the UE 115 measures that a beam 230-a associated with a first channel resource having an antenna location of 220-a has a relatively greatest signal strength, the UE 115 may include, in the CSI report 240, predicted signal strengths for second channel resources of the second set of channel resources that are connected to the first channel resource associated with the beam 230-a. In other words, the CSI report 240 may include predicted L1-RSRPs for set A beams that are connected to the beam 230-a for which the UE 115 measured a strongest L1-RSRP. In the example of the beamforming codebook 215, second channel resources of the second set of channel resources that are associated with antenna locations 225-a, 225-b, 225-c, and 225-d may be connected to the first channel resource having the antenna location of 220-a and the UE 115 may include predicted signal strengths for those second channel resources in the CSI report 240 accordingly.

Likewise, the UE 115 may exclude, from the CSI report 240, predicted signal strengths for a remainder of the second set of channel resources that are not connected to the first channel resource associated with the beam 230-a. In some aspects, the UE 115 may use a receive beam to receive signaling that is scheduled (e.g., in the future) based on a TCI state associated with a second resource of the second set of channel resources, where the receive beam that the UE 115 uses to receive signaling based on the TCI state associated with the second resource may be the same as the receive beam that the UE 115 uses to receive and measure a reference signal via a connected first resource.

As such, the UE 115 may generate and transmit the CSI report 240 including at least one or more predicted signal strengths of one or more channel resources of the second set of channel resources. In some examples, the UE 115 may additionally include one or more measured signal strengths of one or more channel resources of the first set of channel resources in the CSI report 240. The network entity 105 may receive the CSI report 240 and may schedule communication between the UE 115 and the network entity 105 based on the CSI report 240. For example, the network entity 105 may select one or more (uplink or downlink) transmit beams or one or more (uplink or downlink) receive beams, or both, based on the predicted signal strengths included in the CSI report 240 and schedule communication with the UE 115 accordingly.

FIG. 3 illustrates examples of beamforming codebook configurations 300 and 301 that support antenna location configurations for predictive beam management in accordance with one or more aspects of the present disclosure. The example beamforming codebook configurations 300 and 301 may implement or be implemented to realize or facilitate aspects of the wireless communications system 100 or the signaling diagram 200. For example, a UE 115 and a network entity 105, which may be examples of corresponding devices described herein, may support one or both of the beamforming codebook configurations 300 and 301, or a combination of the beamforming codebook configurations 300 and 301, for a beamforming codebook 215 to leverage antenna location-based beam prediction. The beamforming codebook 215 may include multiple codepoints 305 that indicate antenna locations 310 and spatial information for channel resources of a first set of channel resources associated with channel measurement and a second set of channel resources associated with beam prediction. In some aspects, each codepoint 305 may include or be associated with a respective antenna location 310 and respective spatial information of a respective channel resource.

As illustrated by the example beamforming codebook configuration 300, which may be associated with a multi-component beamforming codebook 215, each codepoint 305 may include multiple fields associated with an indication of an antenna location 310 (may be defined as a point from which an associated beam propagates from an antenna array or panel of the network entity 105), an indication of a reference beam shape 315 (e.g., an angular-specific beamforming gain), and an indication of a beam pointing direction 320 (e.g., an indication of a boresight direction). In some examples, the indication of the antenna location 310 may include a value of one of a set of approximately 20 options, the indication of the reference beam shape 315 may include a value of one of a set of approximately 3 options, and the indication of the beam pointing direction 320 may include a value of one of a set of approximately 10 options. In implementations associated with the beamforming codebook configuration 300, the spatial information indicated by the beamforming codebook 215 may include reference beam shapes and beam pointing directions (e.g., boresight directions).

As illustrated by the example beamforming codebook configuration 301, each codepoint 305 may include multiple fields associated with the indication of an antenna location 310 (which may be defined as a center of one or more antenna elements involved in a transmission using an associated beam), an indication of an antenna array structure 325, and an indication of a set of phase shifting values 330. The indication of the antenna array structure 325 may be associated with or otherwise indicate a layout and orientation of a set of antenna elements, where the layouts of the antenna elements may identify distances from an antenna location to respective antenna elements. Further, the indication of the set of phase shifting values 330 may be associated with the respective antenna elements. In implementations associated with the beamforming codebook configuration 301, the spatial information indicated by the beamforming codebook 215 may include the antenna array structure and the set of phase shifting values.

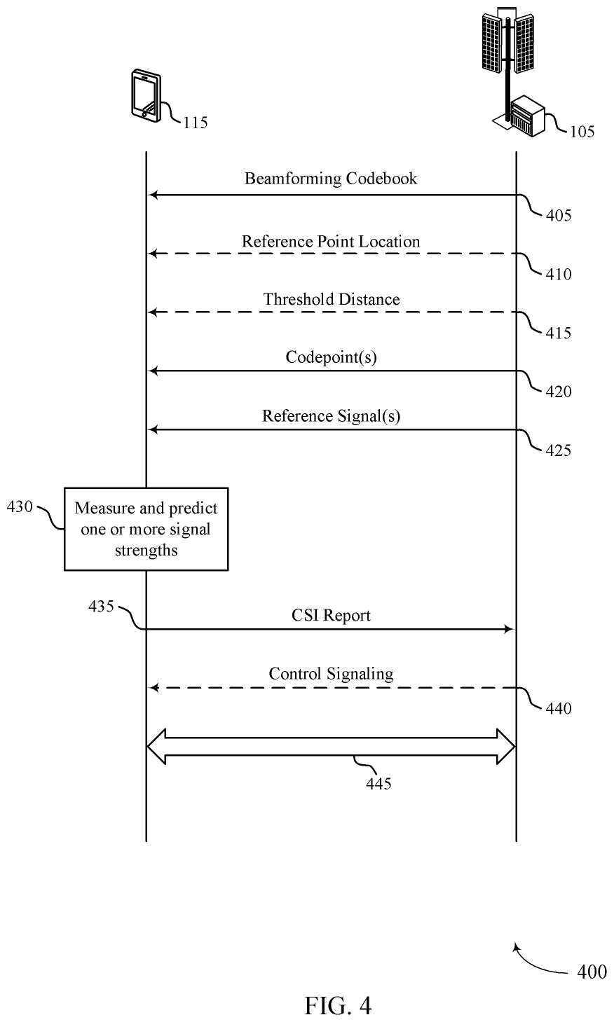

FIG. 4 illustrates an example of a process flow 400 that supports antenna location configurations for predictive beam management in accordance with one or more aspects of the present disclosure. The process flow 400 may implement or be implemented to facilitate or realize aspects of the wireless communications system 100, the signaling diagram 200, the beamforming codebook configuration 300, or the beamforming codebook configuration 301. For example, the process flow 400 illustrates communication between a UE 115 and a network entity 105, which may be examples of corresponding devices as described herein. In some implementations, the UE 115 and the network entity 105 may support a beamforming codebook according to which the UE 115 and the network entity 105 may communicate antenna locations associated with channel resources of both a first set of channel resources associated with channel measurement and a second set of channel resources associated with beam prediction. As such, the UE 115 and the network entity 105 may support beam prediction across various deployments, including deployments in which the network entity 105 supports relatively large antenna panels with multiple sub-arrays.

In the following description of the process flow 400, the operations may be performed (such as reported or provided) in a different order than the order shown, or the operations performed by the example devices may be performed in different orders or at different times. Some operations also may be left out of the process flow 400, or other operations may be added to the process flow 400. Further, although some operations or signaling may be shown to occur at different times for discussion purposes, these operations may actually occur at the same time.

At 405, the UE 115 may receive, from the network entity 105, an indication of a beamforming codebook (e.g., the beamforming codebook 215 as illustrated by and described with reference to FIGS. 2 and 3) associated with a serving cell of the network entity 105. In some implementations, the beamforming codebook may indicate antenna locations (such as antenna locations 220 and antenna locations 225 via an indication of antenna locations 310, as illustrated by and described with reference to FIGS. 2 and 3) and spatial information of a first set of channel resources associated with beam prediction and of a second set of channel resources associated with beam prediction. In some aspects, the antenna locations may be associated with an antenna panel of the network entity 105 that is associated with the serving cell. In some aspects, the beamforming codebook may include multiple codepoints and each codepoint of the multiple codepoints may include a respective antenna location and respective spatial information for a respective channel resource. As such, the codebook may be used to connect set A beams and set B beams for predictive beam management based on one or both of antenna locations and spatial information.

At 410, the UE 115 may receive, from the network entity 105, an indication of a reference point location associated with the antenna panel of the network entity associated with the serving cell. In such implementations in which the UE 115 receives an indication of the reference point location, the antenna locations indicated by the beamforming codebook may be indicated differentially relative to the reference point location.

At 415, the UE 115 may receive, from the network entity 105, an indication of a threshold distance associated with a correspondence between channel resources of the first set of channel resources and channel resources of the second set of channel resources. In such implementations in which the UE 115 receives the indication of the threshold distance, the UE 115 may use the indication to identify, select, ascertain, or otherwise determine connections or associations between the first set of channel resources and the second set of channel resources for beam prediction purposes. For example, if a first channel resource of the first set of channel resources is located within the threshold distance of a second channel resource of the second set of channel resources, the UE 115 may use a signal strength measurement of the first channel resource to predict a signal strength of the second channel resource.

At 420, the UE 115 may receive an indication of one or more codepoints associated with the beamforming codebook. In some aspects, the one or more codepoints may indicate one or more first channel resources from the first set of channel resources for the UE 115 to measure. The UE 115 may additionally use the one or more codepoints to identify one or more second channel resources from the second set of channel resources that are connected or associated with the indicated one or more first channel resources (e.g., based on respective antenna locations). As such, the one or more codepoints may be associated with the one or more second channel resources of the second set of channel resources and the UE 115 may predict signal strengths associated with the one or more second channel resources accordingly. The UE 115 may predict the signal strengths associated with the one or more second channel resources based on channel measurements of the one or more first channel resources.

At 425, the network entity 105 may transmit one or more reference signals via one or more channel resources of the first set of channel resources (e.g., the one or more first channel resources indicated by the one or more codepoints). The UE 115 may receive and measure a set of signal strengths of the one or more reference signals via the one or more channel resources of the first set of channel resources.

At 430, the UE 115 may predict one or more signal strengths associated with one or more channel resources of the second set of channel resources based on a set of channel measurements associated with the one or more channel resources of the first set of channel resources, the antenna locations, and the spatial information. For example, the UE 115 may predict a signal strength for a second channel resource of the second set of channel resources based on a channel measurement of a first channel resource of the first set of channel resources if the first channel resource and the second channel resource are connected or associated based on respective antenna locations or spatial information, or both.

At 435, the UE 115 may transmit, to the network entity 105, a CSI report including the predicted signal strengths associated with the one or more channel resources of the second set of channel resources. In some aspects, the UE 115 may include, in the CSI report, predicted signal strengths for channel resources of the second set of channel resources that are connected or associated with a channel resource of the first set of channel resources for which the UE 115 measures a greatest signal strength (e.g., a signal strength that is a relatively greater signal strength than a remainder of measured signal strengths associated with the first set of channel resources). In some aspects, the UE 115 may include any combination of predicted or measured L1-RSRPs, L1-SINRs, rank indications (RIs), channel quality indicators (CQIs), precoding matrix indicators (PMIs), or layer indicators (LIs).

At 440, the UE 115 may receive control signaling associated with which directional beams are to be used for communication with the network entity 105. For example, the UE 115 may receive an indication of which one or more beams the network entity 105 may use for communication with the UE 115 based on the CSI report (e.g., based on the predicted signal strengths). Additionally, or alternatively, the control signaling may indicate which one or more beams the UE 115 may use for communication with the network entity 105 based on the CSI report (e.g., based on the predicted signal strengths). The UE 115 may receive the control signaling from the network entity 105 via DCI, a MAC-CE, a downlink control channel, a downlink data channel, or a downlink shared channel.

At 445, the UE 115 may communicate with the network entity 105 in accordance with the control signaling and based on the CSI report. For example, the UE 115 may receive downlink signaling from the network entity 105 via downlink beams that the UE 115 predicted to have relatively higher signal strengths in the CSI report, or beams that are otherwise indicated via the control signaling. The UE 115 may communicate with the network entity 105 via one or more control, data, or shared channels.

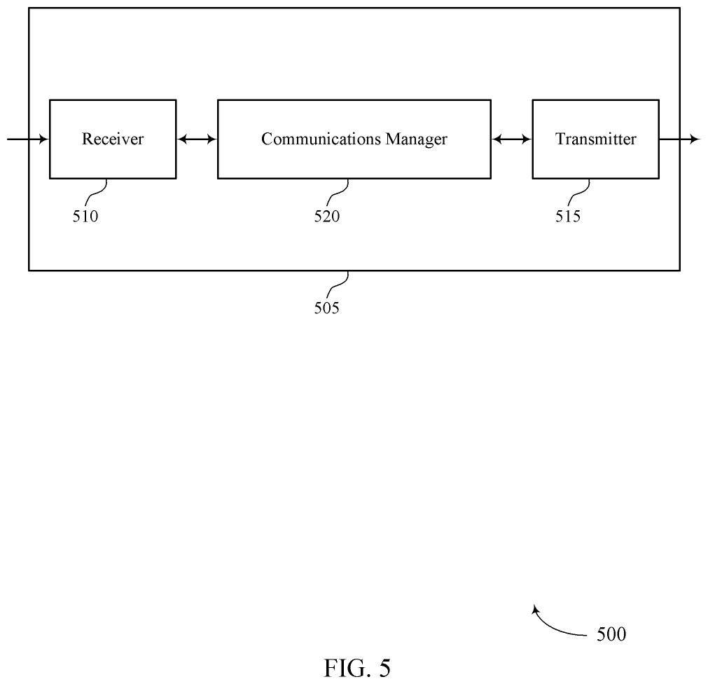

FIG. 5 shows a block diagram 500 of a device 505 that supports antenna location configurations for predictive beam management in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to antenna location configurations for predictive beam management). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to antenna location configurations for predictive beam management). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of antenna location configurations for predictive beam management as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving an indication of a beamforming codebook associated with a serving cell of a network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell. The communications manager 520 may be configured as or otherwise support a means for predicting one or more signal strengths associated with one or more channel resources of the second set of multiple channel resources based on a set of channel measurements associated with channel resources of the first set of multiple channel resources, the antenna locations, and the spatial information. The communications manager 520 may be configured as or otherwise support a means for transmitting, to the network entity, a channel state information report including the predicted one or more signal strengths associated with the one or more channel resources of the second set of multiple channel resources.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources.

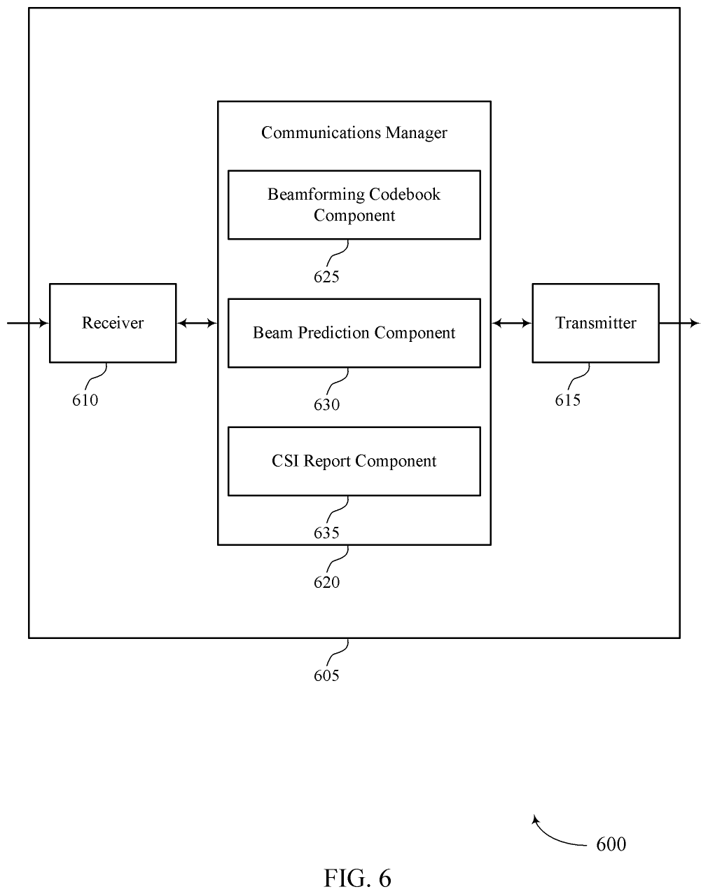

FIG. 6 shows a block diagram 600 of a device 605 that supports antenna location configurations for predictive beam management in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to antenna location configurations for predictive beam management). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to antenna location configurations for predictive beam management). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of antenna location configurations for predictive beam management as described herein. For example, the communications manager 620 may include a beamforming codebook component 625, a beam prediction component 630, a CSI report component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The beamforming codebook component 625 may be configured as or otherwise support a means for receiving an indication of a beamforming codebook associated with a serving cell of a network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell. The beam prediction component 630 may be configured as or otherwise support a means for predicting one or more signal strengths associated with one or more channel resources of the second set of multiple channel resources based on a set of channel measurements associated with channel resources of the first set of multiple channel resources, the antenna locations, and the spatial information. The CSI report component 635 may be configured as or otherwise support a means for transmitting, to the network entity, a channel state information report including the predicted one or more signal strengths associated with the one or more channel resources of the second set of multiple channel resources.

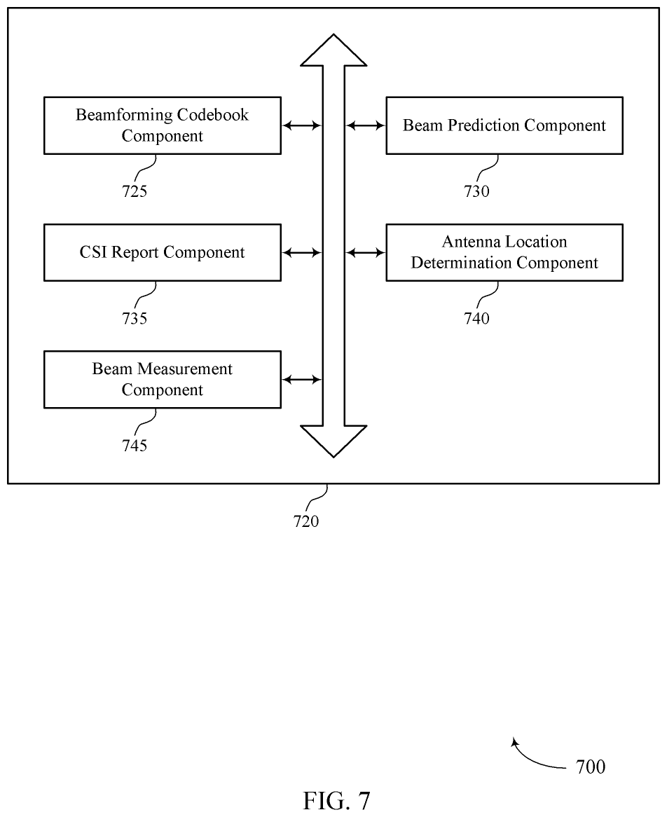

FIG. 7 shows a block diagram 700 of a communications manager 720 that supports antenna location configurations for predictive beam management in accordance with one or more aspects of the present disclosure. The communications manager 720 may be an example of aspects of a communications manager 520, a communications manager 620, or both, as described herein. The communications manager 720, or various components thereof, may be an example of means for performing various aspects of antenna location configurations for predictive beam management as described herein. For example, the communications manager 720 may include a beamforming codebook component 725, a beam prediction component 730, a CSI report component 735, an antenna location determination component 740, a beam measurement component 745, or any combination thereof. Each of these components may communicate, directly or indirectly, with one another (e.g., via one or more buses).

The communications manager 720 may support wireless communication at a UE in accordance with examples as disclosed herein. The beamforming codebook component 725 may be configured as or otherwise support a means for receiving an indication of a beamforming codebook associated with a serving cell of a network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell. The beam prediction component 730 may be configured as or otherwise support a means for predicting one or more signal strengths associated with one or more channel resources of the second set of multiple channel resources based on a set of channel measurements associated with channel resources of the first set of multiple channel resources, the antenna locations, and the spatial information. The CSI report component 735 may be configured as or otherwise support a means for transmitting, to the network entity, a channel state information report including the predicted one or more signal strengths associated with the one or more channel resources of the second set of multiple channel resources.

In some examples, the beamforming codebook component 725 may be configured as or otherwise support a means for receiving an indication of one or more codepoints associated with the beamforming codebook, where the one or more codepoints are associated with the one or more channel resources of the second set of multiple channel resources, and where predicting the one or more signal strengths associated with the one or more channel resources is based on receiving the indication of the one or more codepoints.

In some examples, the antenna location determination component 740 may be configured as or otherwise support a means for receiving an indication of a reference point location associated with the antenna panel of the network entity associated with the serving cell, where the antenna locations indicated by the beamforming codebook are indicated differentially relative to the reference point location.

In some examples, the antenna location determination component 740 may be configured as or otherwise support a means for receiving an indication of a threshold distance associated with a correspondence between channel resources of the first set of multiple channel resources and channel resources of the second set of multiple channel resources, where predicting the one or more signal strengths associated with the one or more channel resources of the second set of multiple channel resources is based on the threshold distance.

In some examples, to support predicting the one or more signal strengths associated with the one or more channel resources of the second set of multiple channel resources, the beam measurement component 745 may be configured as or otherwise support a means for measuring a first signal strength of a first channel resource of the first set of multiple channel resources. In some examples, to support predicting the one or more signal strengths associated with the one or more channel resources of the second set of multiple channel resources, the beam prediction component 730 may be configured as or otherwise support a means for predicting a second signal strength of a second channel resource of the second set of multiple channel resources based at least in part the first signal strength of the first channel resource, where the first channel resource and the second channel resource are associated with each other for beam prediction in accordance with a first antenna location of the first channel resource and a second antenna location of the second channel resource being within the threshold distance of each other.

In some examples, multiple channel resources, including the second channel resource, of the second set of multiple channel resources are associated with antenna locations that are within the threshold distance of the first antenna location of the first channel resource. In some examples, the second channel resource is associated with the first channel resource for beam prediction in accordance with a distance between the first antenna location and the second antenna location being a relatively smallest distance.

In some examples, the indication of the threshold distance is received from the network entity via radio resource control signaling, a medium access control (MAC)-control element (CE), or a DCI message, or any combination thereof.

In some examples, the beam measurement component 745 may be configured as or otherwise support a means for measuring a first signal strength associated with a first channel resource of the first set of multiple channel resources and a second signal strength associated with a second channel resource of the first set of multiple channel resources, where the first channel resource is associated with a first set of channel resources of the second set of multiple channel resources and the second channel resource is associated with a second set of channel resources of the second set of multiple channel resources. In some examples, the CSI report component 735 may be configured as or otherwise support a means for including one of a first set of predicted signal strengths associated with the first set of channel resources or a second set of predicted signal strengths associated with the second set of channel resources in the channel state information report based on whether the first signal strength or the second signal strength is a relatively greater signal strength.

In some examples, the first set of predicted signal strengths associated with the first set of channel resources of the second set of multiple channel resources is included in the channel state information report if the first signal strength is the relatively greater signal strength and the second set of predicted signal strengths associated with the second set of channel resources of the second set of multiple channel resources is included in the channel state information report if the second signal strength is the relatively greater signal strength.

In some examples, the antenna location determination component 740 may be configured as or otherwise support a means for selecting associations between each channel resource of the first set of multiple channel resources and one or more channel resources of the second set of multiple channel resources, where the associations indicate for which one or more channel resources of the second set of multiple channel resources to make signal strength predictions based on a channel measurement of an associated channel resource of the first set of multiple channel resources.

In some examples, the associations are based on the antenna locations of the first set of multiple channel resources and the second set of multiple channel resources first, and are based on the spatial information of the first set of multiple channel resources and the second set of multiple channel resources second.

In some examples, the associations are based on the spatial information of the first set of multiple channel resources and the second set of multiple channel resources first, and are based on the antenna locations of the first set of multiple channel resources and the second set of multiple channel resources second.

In some examples, the beamforming codebook includes a set of multiple codepoints. In some examples, each codepoint of the set of multiple codepoints includes a respective antenna location and respective spatial information for a respective channel resource.

In some examples, each codepoint of the set of multiple codepoints includes information indicative of an antenna location, a reference beam shape, and a beam pointing direction associated with a corresponding channel resource.

In some examples, each codepoint of the set of multiple codepoints includes information indicative of an antenna location, an antenna array structure, and a set of phase shifting values of antenna elements of the antenna array structure associated with a corresponding channel resource.

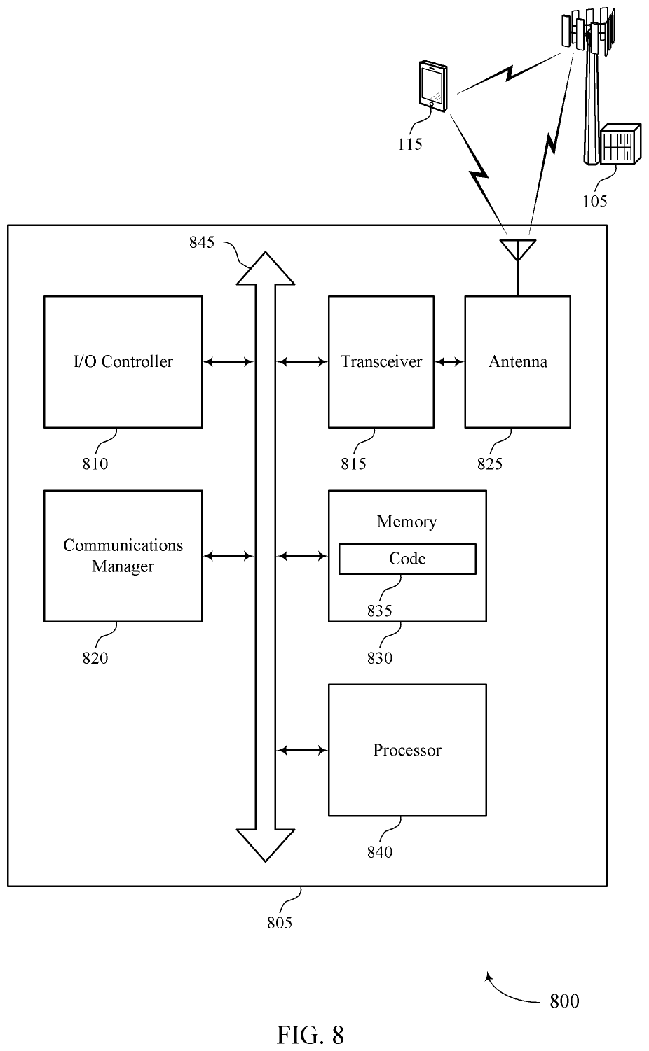

FIG. 8 shows a diagram of a system 800 including a device 805 that supports antenna location configurations for predictive beam management in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting antenna location configurations for predictive beam management). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving an indication of a beamforming codebook associated with a serving cell of a network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell. The communications manager 820 may be configured as or otherwise support a means for predicting one or more signal strengths associated with one or more channel resources of the second set of multiple channel resources based on a set of channel measurements associated with channel resources of the first set of multiple channel resources, the antenna locations, and the spatial information. The communications manager 820 may be configured as or otherwise support a means for transmitting, to the network entity, a channel state information report including the predicted one or more signal strengths associated with the one or more channel resources of the second set of multiple channel resources.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of antenna location configurations for predictive beam management as described herein, or the processor 840 and the memory 830 may be otherwise configured to perform or support such operations.

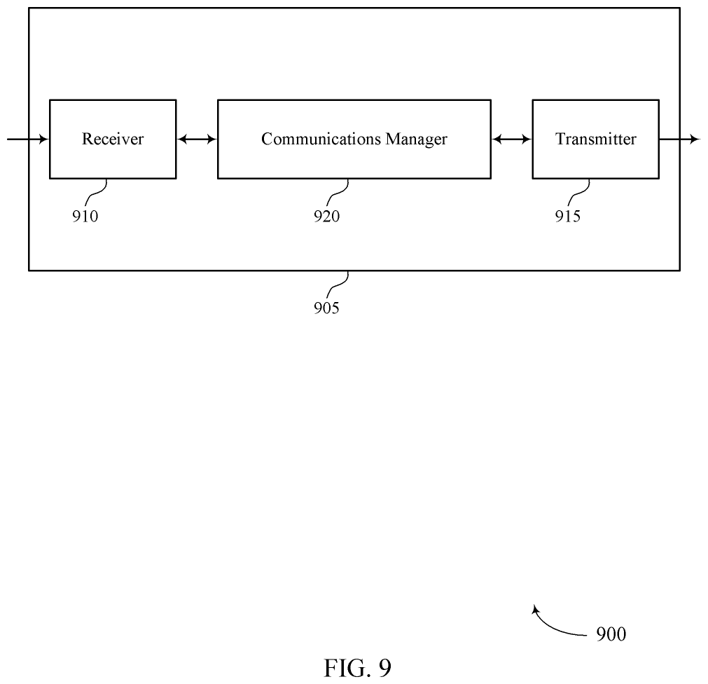

FIG. 9 shows a block diagram 900 of a device 905 that supports antenna location configurations for predictive beam management in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of antenna location configurations for predictive beam management as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting an indication of a beamforming codebook associated with a serving cell of the network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell. The communications manager 920 may be configured as or otherwise support a means for receiving a channel state information report including one or more predicted signal strengths associated with one or more channel resources of the second set of multiple channel resources based on a set of channel measurements associated with channel resources of the first set of multiple channel resources, the antenna locations, and the spatial information.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, and more efficient utilization of communication resources.

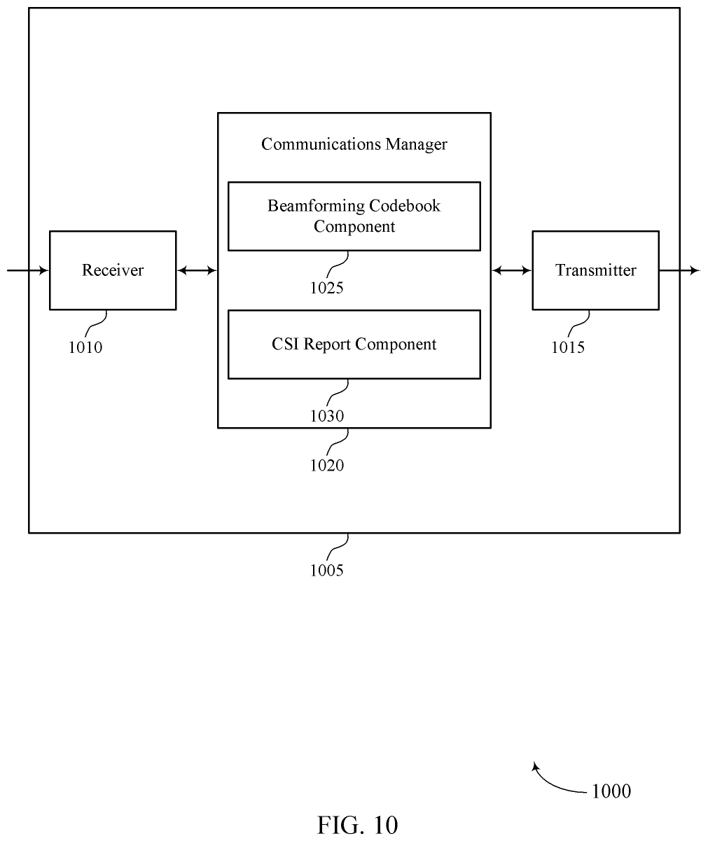

FIG. 10 shows a block diagram 1000 of a device 1005 that supports antenna location configurations for predictive beam management in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of antenna location configurations for predictive beam management as described herein. For example, the communications manager 1020 may include a beamforming codebook component 1025 a CSI report component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The beamforming codebook component 1025 may be configured as or otherwise support a means for transmitting an indication of a beamforming codebook associated with a serving cell of the network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell. The CSI report component 1030 may be configured as or otherwise support a means for receiving a channel state information report including one or more predicted signal strengths associated with one or more channel resources of the second set of multiple channel resources based on a set of channel measurements associated with channel resources of the first set of multiple channel resources, the antenna locations, and the spatial information.

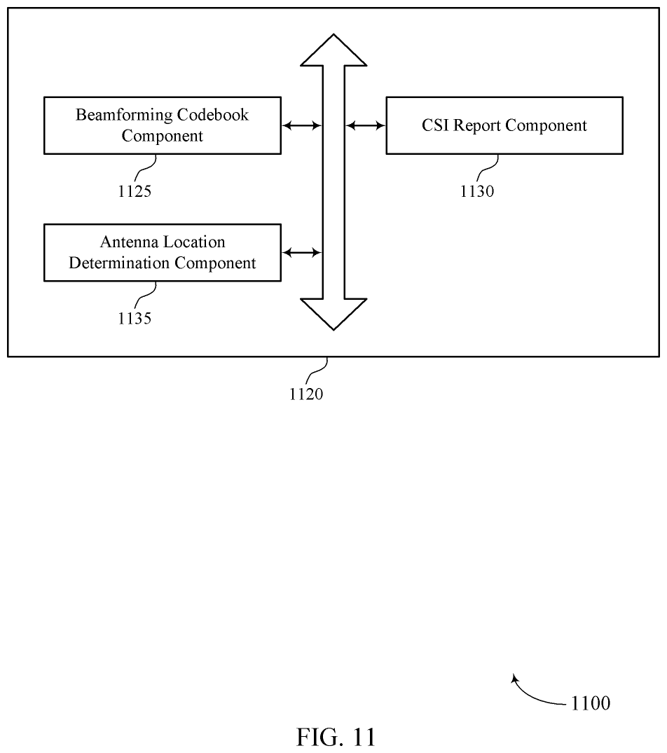

FIG. 11 shows a block diagram 1100 of a communications manager 1120 that supports antenna location configurations for predictive beam management in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of antenna location configurations for predictive beam management as described herein. For example, the communications manager 1120 may include a beamforming codebook component 1125, a CSI report component 1130, an antenna location determination component 1135, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The beamforming codebook component 1125 may be configured as or otherwise support a means for transmitting an indication of a beamforming codebook associated with a serving cell of the network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell. The CSI report component 1130 may be configured as or otherwise support a means for receiving a channel state information report including one or more predicted signal strengths associated with one or more channel resources of the second set of multiple channel resources based on a set of channel measurements associated with channel resources of the first set of multiple channel resources, the antenna locations, and the spatial information.

In some examples, the beamforming codebook component 1125 may be configured as or otherwise support a means for transmitting an indication of one or more codepoints associated with the beamforming codebook, where the one or more codepoints are associated with the one or more channel resources of the second set of multiple channel resources, and where receiving the one or more predicted signal strengths associated with the one or more channel resources is based on transmitting the indication of the one or more codepoints.

In some examples, the antenna location determination component 1135 may be configured as or otherwise support a means for transmitting an indication of a reference point location associated with the antenna panel of the network entity associated with the serving cell, where the antenna locations indicated by the beamforming codebook are indicated differentially relative to the reference point location.

In some examples, the antenna location determination component 1135 may be configured as or otherwise support a means for transmitting an indication of a threshold distance associated with a correspondence between channel resources of the first set of multiple channel resources and channel resources of the second set of multiple channel resources, where receiving the one or more predicted signal strengths associated with the one or more channel resources of the second set of multiple channel resources is based on the threshold distance.

In some examples, to support receiving the channel state information report including the one or more predicted signal strengths, the CSI report component 1130 may be configured as or otherwise support a means for receiving, based at least in part a measurement of a first signal strength of a first channel resource of the first set of multiple channel resources, a predicted signal strength of a second channel resource of the second set of multiple channel resources, where the first channel resource and the second channel resource are associated with each other for beam prediction in accordance with a first antenna location of the first channel resource and a second antenna location of the second channel resource being within the threshold distance of each other.

In some examples, multiple channel resources, including the second channel resource, of the second set of multiple channel resources are associated with antenna locations that are within the threshold distance of the first antenna location of the first channel resource. In some examples, the second channel resource is associated with the first channel resource for beam prediction in accordance with a distance between the first antenna location and the second antenna location being a relatively smallest distance.

In some examples, the indication of the threshold distance is transmitted via radio resource control signaling, a medium access control (MAC)-control element (CE), or a DCI message, or any combination thereof.

In some examples, to support receiving the channel state information report including the one or more predicted signal strengths, the CSI report component 1130 may be configured as or otherwise support a means for receiving one of a first set of predicted signal strengths associated with a first set of channel resources or a second set of predicted signal strengths associated with a second set of channel resources, where the one of the first set of predicted signal strengths or the second set of predicted signal strengths is based on whether a first signal strength associated with a first channel resource of the first set of multiple channel resources or a second signal strength associated with a second channel resource of the first set of multiple channel resources is a relatively greater signal strength, where the first channel resource is associated with the first set of channel resources of the second set of multiple channel resources and the second channel resource is associated with the second set of channel resources of the second set of multiple channel resources.

In some examples, the first set of predicted signal strengths associated with the first set of channel resources of the second set of multiple channel resources is included in the channel state information report if the first signal strength is the relatively greater signal strength and the second set of predicted signal strengths associated with the second set of channel resources of the second set of multiple channel resources is included in the channel state information report if the second signal strength is the relatively greater signal strength.

In some examples, the antenna location determination component 1135 may be configured as or otherwise support a means for selecting associations between each channel resource of the first set of multiple channel resources and one or more channel resources of the second set of multiple channel resources, where the associations indicate for which one or more channel resources of the second set of multiple channel resources a UE is to make signal strength predictions based on a channel measurement of an associated channel resource of the first set of multiple channel resources.

In some examples, the associations are based on the antenna locations of the first set of multiple channel resources and the second set of multiple channel resources first, and are based on the spatial information of the first set of multiple channel resources and the second set of multiple channel resources second.

In some examples, the associations are based on the spatial information of the first set of multiple channel resources and the second set of multiple channel resources first, and are based on the antenna locations of the first set of multiple channel resources and the second set of multiple channel resources second.

In some examples, the beamforming codebook includes a set of multiple codepoints. In some examples, each codepoint of the set of multiple codepoints includes a respective antenna location and respective spatial information for a respective channel resource.

In some examples, each codepoint of the set of multiple codepoints includes information indicative of an antenna location, a reference beam shape, and a beam pointing direction associated with a corresponding channel resource.

In some examples, each codepoint of the set of multiple codepoints includes information indicative of an antenna location, an antenna array structure, and a set of phase shifting values of antenna elements of the antenna array structure associated with a corresponding channel resource.

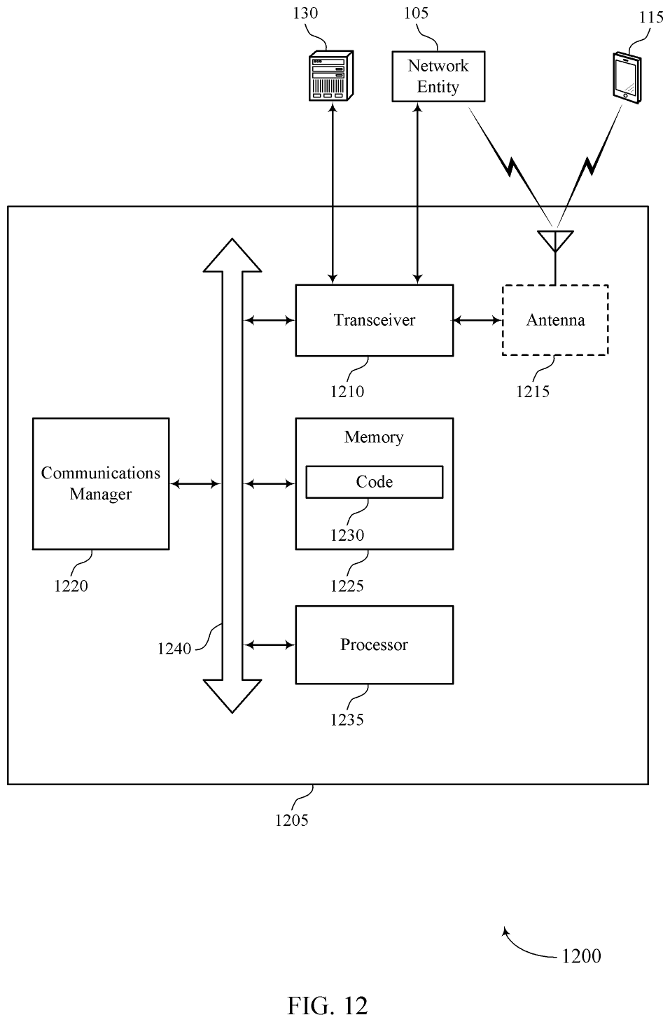

FIG. 12 shows a diagram of a system 1200 including a device 1205 that supports antenna location configurations for predictive beam management in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals.

In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting antenna location configurations for predictive beam management). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225).

In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both.

The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting an indication of a beamforming codebook associated with a serving cell of the network entity, where the beamforming codebook indicates antenna locations and spatial information of a first set of multiple channel resources associated with channel measurement and a second set of multiple channel resources associated with beam prediction, the antenna locations being associated with an antenna panel of the network entity that is associated with the serving cell. The communications manager 1220 may be configured as or otherwise support a means for receiving a channel state information report including one or more predicted signal strengths associated with one or more channel resources of the second set of multiple channel resources based on a set of channel measurements associated with channel resources of the first set of multiple channel resources, the antenna locations, and the spatial information.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of antenna location configurations for predictive beam management as described herein, or the processor 1235 and the memory 1225 may be otherwise configured to perform or support such operations.

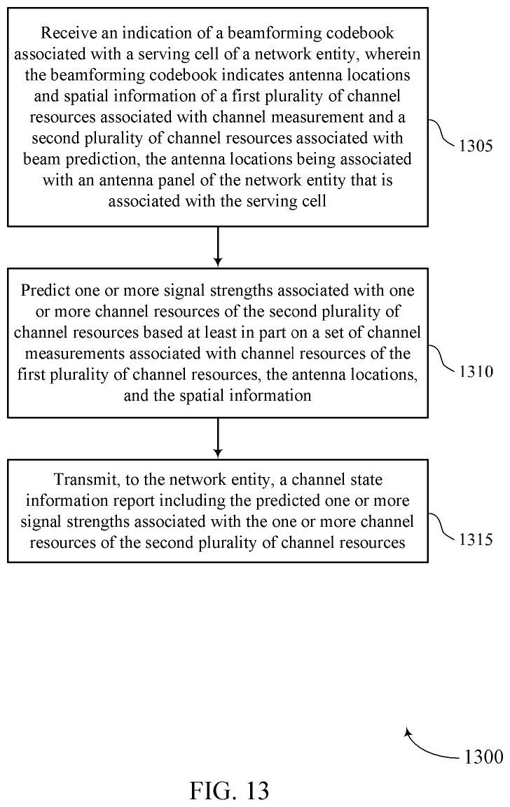

FIG. 13 shows a flowchart illustrating a method 1300 that supports antenna location configurations for predictive beam management in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a beamforming codebook associated with a serving cell of a network entity, wherein the beamforming codebook indicates antenna locations and spatial information of a first plurality of channel resources associated with channel measurement and a second plurality of channel resources associated with beam prediction, the antenna locations being associated with an antenna panel of the network entity that is associated with the serving cell. The operations of 1305 may be performed in accordance with examples as disclosed herein. In some examples, aspects of the operations of 1305 may be performed by a beamforming codebook component 725 as described with reference to FIG. 7.

At 1310, the method may include predicting one or more signal strengths associated with one or more channel resources of the second plurality of channel resources based at least in part on a set of channel measurements associated with channel resources of the first plurality of channel resources, the antenna locations, and the spatial information. The operations of 1310 may be performed in accordance with examples as disclosed herein. In some examples, aspects of the operations of 1310 may be performed by a beam prediction component 730 as described with reference to FIG. 7.

At 1315, the method may include transmitting, to the network entity, a channel state information report including the predicted one or more signal strengths associated with the one or more channel resources of the second plurality of channel resources. The operations of 1315 may be performed in accordance with examples as disclosed herein. In some examples, aspects of the operations of 1315 may be performed by a CSI report component 735 as described with reference to FIG. 7.

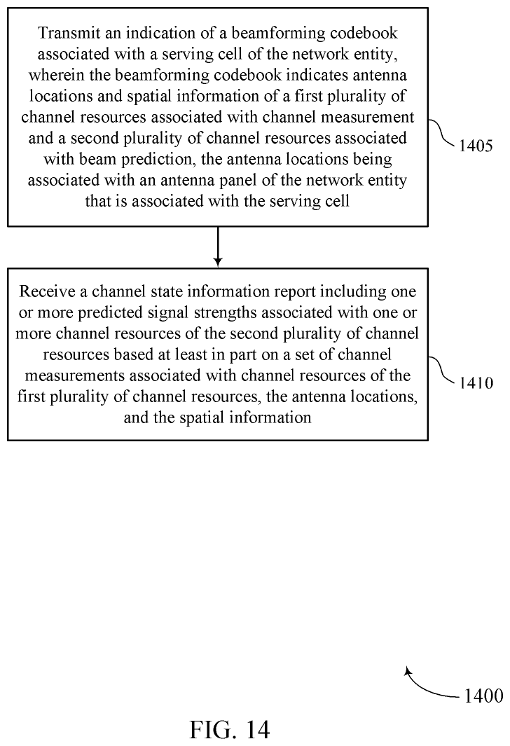

FIG. 14 shows a flowchart illustrating a method 1400 that supports antenna location configurations for predictive beam management in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting an indication of a beamforming codebook associated with a serving cell of the network entity, wherein the beamforming codebook indicates antenna locations and spatial information of a first plurality of channel resources associated with channel measurement and a second plurality of channel resources associated with beam prediction, the antenna locations being associated with an antenna panel of the network entity that is associated with the serving cell. The operations of 1405 may be performed in accordance with examples as disclosed herein. In some examples, aspects of the operations of 1405 may be performed by a beamforming codebook component 1125 as described with reference to FIG. 11.

At 1410, the method may include receiving a channel state information report including one or more predicted signal strengths associated with one or more channel resources of the second plurality of channel resources based at least in part on a set of channel measurements associated with channel resources of the first plurality of channel resources, the antenna locations, and the spatial information. The operations of 1410 may be performed in accordance with examples as disclosed herein. In some examples, aspects of the operations of 1410 may be performed by a CSI report component 1130 as described with reference to FIG. 11.

The following provides an overview of aspects of the present disclosure:

Aspect 1: A method for wireless communication at a UE, comprising: receiving an indication of a beamforming codebook associated with a serving cell of a network entity, wherein the beamforming codebook indicates antenna locations and spatial information of a first plurality of channel resources associated with channel measurement and a second plurality of channel resources associated with beam prediction, the antenna locations being associated with an antenna panel of the network entity that is associated with the serving cell; predicting one or more signal strengths associated with one or more channel resources of the second plurality of channel resources based at least in part on a set of channel measurements associated with channel resources of the first plurality of channel resources, the antenna locations, and the spatial information; and transmitting, to the network entity, a CSI report including the predicted one or more signal strengths associated with the one or more channel resources of the second plurality of channel resources.

Aspect 2: The method of aspect 1, further comprising: receiving an indication of one or more codepoints associated with the beamforming codebook, wherein the one or more codepoints are associated with the one or more channel resources of the second plurality of channel resources, and wherein predicting the one or more signal strengths associated with the one or more channel resources is based at least in part on receiving the indication of the one or more codepoints.

Aspect 3: The method of any of aspects 1 through 2, further comprising: receiving an indication of a reference point location associated with the antenna panel of the network entity associated with the serving cell, wherein the antenna locations indicated by the beamforming codebook are indicated differentially relative to the reference point location.

Aspect 4: The method of any of aspects 1 through 3, further comprising: receiving an indication of a threshold distance associated with a correspondence between channel resources of the first plurality of channel resources and channel resources of the second plurality of channel resources, wherein predicting the one or more signal strengths associated with the one or more channel resources of the second plurality of channel resources is based at least in part on the threshold distance.

Aspect 5: The method of aspect 4, wherein predicting the one or more signal strengths associated with the one or more channel resources of the second plurality of channel resources comprises: measuring a first signal strength of a first channel resource of the first plurality of channel resources; and predicting a second signal strength of a second channel resource of the second plurality of channel resources based at least in part the first signal strength of the first channel resource, wherein the first channel resource and the second channel resource are associated with each other for beam prediction in accordance with a first antenna location of the first channel resource and a second antenna location of the second channel resource being within the threshold distance of each other.

Aspect 6: The method of aspect 5, wherein multiple channel resources, including the second channel resource, of the second plurality of channel resources are associated with antenna locations that are within the threshold distance of the first antenna location of the first channel resource, and the second channel resource is associated with the first channel resource for beam prediction in accordance with a distance between the first antenna location and the second antenna location being a relatively smallest distance.

Aspect 7: The method of any of aspects 4 through 6, wherein the indication of the threshold distance is received from the network entity via RRC signaling, a MAC-CE, or a DCI message, or any combination thereof.

Aspect 8: The method of any of aspects 1 through 7, further comprising: measuring a first signal strength associated with a first channel resource of the first plurality of channel resources and a second signal strength associated with a second channel resource of the first plurality of channel resources, wherein the first channel resource is associated with a first set of channel resources of the second plurality of channel resources and the second channel resource is associated with a second set of channel resources of the second plurality of channel resources; and including one of a first set of predicted signal strengths associated with the first set of channel resources or a second set of predicted signal strengths associated with the second set of channel resources in the CSI report based at least in part on whether the first signal strength or the second signal strength is a relatively greater signal strength.

Aspect 9: The method of aspect 8, wherein the first set of predicted signal strengths associated with the first set of channel resources of the second plurality of channel resources is included in the CSI report if the first signal strength is the relatively greater signal strength and the second set of predicted signal strengths associated with the second set of channel resources of the second plurality of channel resources is included in the CSI report if the second signal strength is the relatively greater signal strength.

Aspect 10: The method of any of aspects 1 through 9, further comprising: selecting associations between each channel resource of the first plurality of channel resources and one or more channel resources of the second plurality of channel resources, wherein the associations indicate for which one or more channel resources of the second plurality of channel resources to make signal strength predictions based on a channel measurement of an associated channel resource of the first plurality of channel resources.

Aspect 11: The method of aspect 10, wherein the associations are based at least in part on the antenna locations of the first plurality of channel resources and the second plurality of channel resources first, and are based at least in part on the spatial information of the first plurality of channel resources and the second plurality of channel resources second.

Aspect 12: The method of aspect 10, wherein the associations are based at least in part on the spatial information of the first plurality of channel resources and the second plurality of channel resources first, and are based at least in part on the antenna locations of the first plurality of channel resources and the second plurality of channel resources second.

Aspect 13: The method of any of aspects 1 through 12, wherein the beamforming codebook includes a plurality of codepoints, and each codepoint of the plurality of codepoints includes a respective antenna location and respective spatial information for a respective channel resource.

Aspect 14: The method of aspect 13, wherein each codepoint of the plurality of codepoints includes information indicative of an antenna location, a reference beam shape, and a beam pointing direction associated with a corresponding channel resource.

Aspect 15: The method of any of aspects 13 through 14, wherein each codepoint of the plurality of codepoints includes information indicative of an antenna location, an antenna array structure, and a set of phase shifting values of antenna elements of the antenna array structure associated with a corresponding channel resource.

Aspect 16: A method for wireless communication at a network entity, comprising: transmitting an indication of a beamforming codebook associated with a serving cell of the network entity, wherein the beamforming codebook indicates antenna locations and spatial information of a first plurality of channel resources associated with channel measurement and a second plurality of channel resources associated with beam prediction, the antenna locations being associated with an antenna panel of the network entity that is associated with the serving cell; and receiving a CSI report including one or more predicted signal strengths associated with one or more channel resources of the second plurality of channel resources based at least in part on a set of channel measurements associated with channel resources of the first plurality of channel resources, the antenna locations, and the spatial information.

Aspect 17: The method of aspect 16, further comprising: transmitting an indication of one or more codepoints associated with the beamforming codebook, wherein the one or more codepoints are associated with the one or more channel resources of the second plurality of channel resources, and wherein receiving the one or more predicted signal strengths associated with the one or more channel resources is based at least in part on transmitting the indication of the one or more codepoints.

Aspect 18: The method of any of aspects 16 through 17, further comprising: transmitting an indication of a reference point location associated with the antenna panel of the network entity associated with the serving cell, wherein the antenna locations indicated by the beamforming codebook are indicated differentially relative to the reference point location.

Aspect 19: The method of any of aspects 16 through 18, further comprising: transmitting an indication of a threshold distance associated with a correspondence between channel resources of the first plurality of channel resources and channel resources of the second plurality of channel resources, wherein receiving the one or more predicted signal strengths associated with the one or more channel resources of the second plurality of channel resources is based at least in part on the threshold distance.

Aspect 20: The method of aspect 19, wherein receiving the CSI report including the one or more predicted signal strengths comprises: receiving, based at least in part a measurement of a first signal strength of a first channel resource of the first plurality of channel resources, a predicted signal strength of a second channel resource of the second plurality of channel resources, wherein the first channel resource and the second channel resource are associated with each other for beam prediction in accordance with a first antenna location of the first channel resource and a second antenna location of the second channel resource being within the threshold distance of each other.

Aspect 21: The method of aspect 20, wherein multiple channel resources, including the second channel resource, of the second plurality of channel resources are associated with antenna locations that are within the threshold distance of the first antenna location of the first channel resource, and the second channel resource is associated with the first channel resource for beam prediction in accordance with a distance between the first antenna location and the second antenna location being a relatively smallest distance.

Aspect 22: The method of any of aspects 19 through 21, wherein the indication of the threshold distance is transmitted via RRC signaling, a medium access control MAC-CE, or a DCI message, or any combination thereof.

Aspect 23: The method of any of aspects 16 through 22, wherein receiving the CSI report including the one or more predicted signal strengths comprises: receiving one of a first set of predicted signal strengths associated with a first set of channel resources or a second set of predicted signal strengths associated with a second set of channel resources, wherein the one of the first set of predicted signal strengths or the second set of predicted signal strengths is based at least in part on whether a first signal strength associated with a first channel resource of the first plurality of channel resources or a second signal strength associated with a second channel resource of the first plurality of channel resources is a relatively greater signal strength, wherein the first channel resource is associated with the first set of channel resources of the second plurality of channel resources and the second channel resource is associated with the second set of channel resources of the second plurality of channel resources.

Aspect 24: The method of aspect 23, wherein the first set of predicted signal strengths associated with the first set of channel resources of the second plurality of channel resources is included in the CSI report if the first signal strength is the relatively greater signal strength and the second set of predicted signal strengths associated with the second set of channel resources of the second plurality of channel resources is included in the CSI report if the second signal strength is the relatively greater signal strength.

Aspect 25: The method of any of aspects 16 through 24, further comprising: selecting associations between each channel resource of the first plurality of channel resources and one or more channel resources of the second plurality of channel resources, wherein the associations indicate for which one or more channel resources of the second plurality of channel resources a UE is to make signal strength predictions based on a channel measurement of an associated channel resource of the first plurality of channel resources.

Aspect 26: The method of aspect 25, wherein the associations are based at least in part on the antenna locations of the first plurality of channel resources and the second plurality of channel resources first, and are based at least in part on the spatial information of the first plurality of channel resources and the second plurality of channel resources second.

Aspect 27: The method of aspect 25, wherein the associations are based at least in part on the spatial information of the first plurality of channel resources and the second plurality of channel resources first, and are based at least in part on the antenna locations of the first plurality of channel resources and the second plurality of channel resources second.

Aspect 28: The method of any of aspects 16 through 27, wherein the beamforming codebook includes a plurality of codepoints, and each codepoint of the plurality of codepoints includes a respective antenna location and respective spatial information for a respective channel resource.

Aspect 29: The method of aspect 28, wherein each codepoint of the plurality of codepoints includes information indicative of an antenna location, a reference beam shape, and a beam pointing direction associated with a corresponding channel resource.

Aspect 30: The method of any of aspects 28 through 29, wherein each codepoint of the plurality of codepoints includes information indicative of an antenna location, an antenna array structure, and a set of phase shifting values of antenna elements of the antenna array structure associated with a corresponding channel resource.

Aspect 31: An apparatus for wireless communication at a UE, comprising at least one processor; memory coupled with the at least one processor; and instructions stored in the memory and executable by the at least one processor to cause the UE to perform a method of any of aspects 1 through 15.

Aspect 32: An apparatus for wireless communication at a UE, comprising at least one means for performing a method of any of aspects 1 through 15.

Aspect 33: A non-transitory computer-readable medium storing code for wireless communication at a UE, the code comprising instructions executable by at least one processor to perform a method of any of aspects 1 through 15.

Aspect 34: An apparatus for wireless communication at a network entity, comprising at least one processor; memory coupled with the at least one processor; and instructions stored in the memory and executable by the at least one processor to cause the network entity to perform a method of any of aspects 16 through 30.

Aspect 35: An apparatus for wireless communication at a network entity, comprising at least one means for performing a method of any of aspects 16 through 30.

Aspect 36: A non-transitory computer-readable medium storing code for wireless communication at a network entity, the code comprising instructions executable by at least one processor to perform a method of any of aspects 16 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), or ascertaining. Also, “determining” can include receiving (e.g., receiving information) or accessing (e.g., accessing data stored in memory). Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
at least one processor; and
memory coupled with the at least one processor, the memory storing instructions executable by the at least one processor to cause the UE to:
receive an indication of a beamforming codebook associated with a serving cell of a network entity, wherein the beamforming codebook indicates antenna locations and spatial information of a first plurality of channel resources associated with channel measurement and a second plurality of channel resources associated with beam prediction, the antenna locations being associated with an antenna panel of the network entity that is associated with the serving cell; predict one or more signal strengths associated with one or more channel resources of the second plurality of channel resources based at least in part on a set of channel measurements associated with channel resources of the first plurality of channel resources, the antenna locations, and the spatial information; and
transmit, to the network entity, a channel state information report including the predicted one or more signal strengths associated with the one or more channel resources of the second plurality of channel resources.

2. The apparatus of claim 1, wherein the instructions are further executable by the at least one processor to cause the UE to:
receive an indication of one or more codepoints associated with the beamforming codebook, wherein the one or more codepoints are associated with the one or more channel resources of the second plurality of channel resources, and wherein predicting the one or more signal strengths associated with the one or more channel resources is based at least in part on receiving the indication of the one or more codepoints.

3. The apparatus of claim 1, wherein the instructions are further executable by the at least one processor to cause the UE to:
receive an indication of a reference point location associated with the antenna panel of the network entity associated with the serving cell, wherein the antenna locations indicated by the beamforming codebook are indicated differentially relative to the reference point location.

4. The apparatus of claim 1, wherein the instructions are further executable by the at least one processor to cause the UE to:
receive an indication of a threshold distance associated with a correspondence between channel resources of the first plurality of channel resources and channel resources of the second plurality of channel resources, wherein predicting the one or more signal strengths associated with the one or more channel resources of the second plurality of channel resources is based at least in part on the threshold distance.

5. The apparatus of claim 4, wherein the instructions to predict the one or more signal strengths associated with the one or more channel resources of the second plurality of channel resources are executable by the at least one processor to cause the UE to:
measure a first signal strength of a first channel resource of the first plurality of channel resources; and
predict a second signal strength of a second channel resource of the second plurality of channel resources based at least in part the first signal strength of the first channel resource, wherein the first channel resource and the second channel resource are associated with each other for beam prediction in accordance with a first antenna location of the first channel resource and a second antenna location of the second channel resource being within the threshold distance of each other.

6. The apparatus of claim 5, wherein multiple channel resources, including the second channel resource, of the second plurality of channel resources are associated with antenna locations that are within the threshold distance of the first antenna location of the first channel resource, and wherein the second channel resource is associated with the first channel resource for beam prediction in accordance with a distance between the first antenna location and the second antenna location being a relatively smallest distance.

7. The apparatus of claim 4, wherein the indication of the threshold distance is received from the network entity via radio resource control signaling, a medium access control (MAC)-control element (CE), or a downlink control information (DCI) message, or any combination thereof.

8. The apparatus of claim 1, wherein the instructions are further executable by the at least one processor to cause the UE to:
measure a first signal strength associated with a first channel resource of the first plurality of channel resources and a second signal strength associated with a second channel resource of the first plurality of channel resources, wherein the first channel resource is associated with a first set of channel resources of the second plurality of channel resources and the second channel resource is associated with a second set of channel resources of the second plurality of channel resources; and
include one of a first set of predicted signal strengths associated with the first set of channel resources or a second set of predicted signal strengths associated with the second set of channel resources in the channel state information report based at least in part on whether the first signal strength or the second signal strength is a relatively greater signal strength.

9. The apparatus of claim 8, wherein the first set of predicted signal strengths associated with the first set of channel resources of the second plurality of channel resources is included in the channel state information report if the first signal strength is the relatively greater signal strength and the second set of predicted signal strengths associated with the second set of channel resources of the second plurality of channel resources is included in the channel state information report if the second signal strength is the relatively greater signal strength.

10. The apparatus of claim 1, wherein the instructions are further executable by the at least one processor to cause the UE to:
select associations between each channel resource of the first plurality of channel resources and one or more channel resources of the second plurality of channel resources, wherein the associations indicate for which one or more channel resources of the second plurality of channel resources to make signal strength predictions based on a channel measurement of an associated channel resource of the first plurality of channel resources.

11. The apparatus of claim 10, wherein the associations are based at least in part on the antenna locations of the first plurality of channel resources and the second plurality of channel resources first, and are based at least in part on the spatial information of the first plurality of channel resources and the second plurality of channel resources second.

12. The apparatus of claim 10, wherein the associations are based at least in part on the spatial information of the first plurality of channel resources and the second plurality of channel resources first, and are based at least in part on the antenna locations of the first plurality of channel resources and the second plurality of channel resources second.

13. The apparatus of claim 1, wherein the beamforming codebook includes a plurality of codepoints, and wherein each codepoint of the plurality of codepoints includes a respective antenna location and respective spatial information for a respective channel resource.

14. The apparatus of claim 13, wherein each codepoint of the plurality of codepoints includes information indicative of an antenna location, a reference beam shape, and a beam pointing direction associated with a corresponding channel resource.

15. The apparatus of claim 13, wherein each codepoint of the plurality of codepoints includes information indicative of an antenna location, an antenna array structure, and a set of phase shifting values of antenna elements of the antenna array structure associated with a corresponding channel resource.

16. An apparatus for wireless communication at a network entity, comprising:
at least one processor; and
memory coupled with the at least one processor, the memory storing instructions executable by the at least one processor to cause the network entity to:
transmit an indication of a beamforming codebook associated with a serving cell of the network entity, wherein the beamforming codebook indicates antenna locations and spatial information of a first plurality of channel resources associated with channel measurement and a second plurality of channel resources associated with beam prediction, the antenna locations being associated with an antenna panel of the network entity that is associated with the serving cell; and receive a channel state information report including one or more predicted signal strengths associated with one or more channel resources of the second plurality of channel resources based at least in part on a set of channel measurements associated with channel resources of the first plurality of channel resources, the antenna locations, and the spatial information.

17. The apparatus of claim 16, wherein the instructions are further executable by the at least one processor to cause the network entity to:
transmit an indication of one or more codepoints associated with the beamforming codebook, wherein the one or more codepoints are associated with the one or more channel resources of the second plurality of channel resources, and wherein receiving the one or more predicted signal strengths associated with the one or more channel resources is based at least in part on transmitting the indication of the one or more codepoints.

18. The apparatus of claim 16, wherein the instructions are further executable by the at least one processor to cause the network entity to:
transmit an indication of a reference point location associated with the antenna panel of the network entity associated with the serving cell, wherein the antenna locations indicated by the beamforming codebook are indicated differentially relative to the reference point location.

19. The apparatus of claim 16, wherein the instructions are further executable by the at least one processor to cause the network entity to:
transmit an indication of a threshold distance associated with a correspondence between channel resources of the first plurality of channel resources and channel resources of the second plurality of channel resources, wherein receiving the one or more predicted signal strengths associated with the one or more channel resources of the second plurality of channel resources is based at least in part on the threshold distance.

20. (canceled)

21. (canceled)

22. (canceled)

23. (canceled)

24. (canceled)

25. (canceled)

26. (canceled)

27. (canceled)

28. (canceled)

29. A method for wireless communication at a user equipment (UE), comprising:
receiving an indication of a beamforming codebook associated with a serving cell of a network entity, wherein the beamforming codebook indicates antenna locations and spatial information of a first plurality of channel resources associated with channel measurement and a second plurality of channel resources associated with beam prediction, the antenna locations being associated with an antenna panel of the network entity that is associated with the serving cell;
predicting one or more signal strengths associated with one or more channel resources of the second plurality of channel resources based at least in part on a set of channel measurements associated with channel resources of the first plurality of channel resources, the antenna locations, and the spatial information; and
transmitting, to the network entity, a channel state information report including the predicted one or more signal strengths associated with the one or more channel resources of the second plurality of channel resources.

30. (canceled)
